(19) United States
(12) Patent Application Publication
(10) Pub. No.: US 2008/0107789 A1
(43) Pub. Date: May 8, 2008

(54) Composition composed of highly dispersible cellulose complex and polysaccharide

(75) Inventor: Mitsuyo Akimoto, Tokyo (JP)

Correspondence Address: STAAS & HALSEY LLP, SUITE 700, 1201 NEW YORK AVENUE, N.W., WASHINGTON, DC, 20005, US

(73) Assignee: Asahi Kasei Chemicals Corporation, Tokyo (JP)

(21) Appl. No.: 11/808,115

(22) Filed: Jun. 6, 2007

Related U.S. Application Data
(63) Continuation-in-part of application No. PCT/JP05/22359, filed on Dec. 6, 2005.

(30) Foreign Application Priority Data
Dec. 6, 2004 (JP) 2004-352169
Feb. 2, 2005 (JP) 2005-025915
Mar. 28, 2005 (JP) 2005-090467
Mar. 28, 2005 (JP) 2005-090487
Jun. 29, 2005 (JP) 2005-189241
Oct. 16, 2006 (JP) 2006-281328
Oct. 16, 2006 (JP) 2006-281517

(51) Int. Cl. A23L 1/0534

(52) U.S. Cl. 426/573; 426/654

(57) ABSTRACT

The present invention provides a stabilizer for stable retention and/or immobilization of grains of flesh, etc. of foods, a thickening agent capable of imparting viscosity through addition of a small amount thereof, and a gelling agent having excellent heat resistance. The present invention provides a composition comprising a polysaccharide and a highly dispersible cellulose complex composed of a hydrophilic substance, a water-soluble polymer and a water-dispersible cellulose being fine-fibrous cellulose from plant cell walls as a raw material. Further, there are provided a stabilizer, thickening and gelling agent comprising the above composition.

### CROSS-REFERENCE

This application is a continuation-in-part of PCT/JP2005/022359 filed Dec. 6, 2005, the content of which is herein incorporated by reference in entirety.

### BACKGROUND OF THE INVENTION

(1) Field of the Invention

The present invention relates to a composition comprising a water-dispersible cellulose or a highly dispersible cellulose complex consisting of a water-dispersible cellulose, a water-soluble polymer and a hydrophilic substance, which is a fine-fibrous cellulose, and at least one kind of polysaccharide, characterized in that the composition has a grain immobilization ability, high thickening ability and structural viscosity, or ability to form a heat-resistant gel.

(2) Description of Related Art

Conventionally, polysaccharides such as galactomannan, glucomannan and xanthan gum have been used as a thickening agent to thicken a food or similar product. If trying to impart a grain immobilization ability, such as preventing sedimentation or floating of fruit pulp or the like just by using these polysaccharides, it is necessary to impart very high viscosity. This results in a deterioration in liquid drainability, whereby the texture in food items worsens as a consequence of a sense of pasty feeling, and the commercial value is harmed. Thus, there is a need for a stabilizer which has good liquid drainability without any sense of pasty feeling, which at the same time retains the grains in the food item in a stable manner. Meanwhile, the amount of thickening agent which can be added into a food item is generally restricted by product design, so that there is a need for a thickening agent which can exhibit a desired thickening effect using the smallest amount possible.

Other known examples of commonly commercially-available gelling agents include gelatin, agar, gellan gum and the like. While a gel can be formed from a mixture of glucomannan and xanthan gum, a mixture of locust bean gum and xanthan gum and similar mixtures, such a gel has a texture like that of konjac jelly. It has thus been difficult to provide the physical properties which are preferred for general food items.

Gelatin has suitable elasticity, and is one of the gelling agents having the most preferred physical properties and texture. However, because gelatin is derived from animals, there is the risk of BSE. In addition, a gel made from gelatin easily melts at ordinary temperatures. Agar is another gelling agent which has preferred physical properties and texture, although as with gelatin, agar also does not have a high heat resistance. Further, while gellan gum has a comparatively high heat resistance, a gel made from gellan gum will completely melt in a retort sterilization treatment in which the temperature is usually heated to 105° C. or more, whereby it is difficult to maintain the contents, such as solids or protein, in their original state. In addition, a gel made from gellan gum suffers from the drawback that it has physical properties which are extremely brittle and that a large amount of water separates after rupture.

Accordingly, there is a need for a gelling agent which exhibits the physical properties of gelatin or agar, is plant-derived, and when used to form a gel, such gel is capable of having heat resistance which can hold contents, such as solids or protein, in their original state even when subjected to a retort sterilization treatment.

Materials such as microfibrous cellulose and cellulose nanofibrils are known as fine-fibrous cellulose made from plant cell walls as a raw material. While fine-fibrous cellulose is appreciated for its fairly high thickening effects, because it has a higher price than a typical polysaccharide, in view of cost it is difficult to use alone. Further, as will be described below, since the “fineness” of such cellulose is insufficient, the roughness of the cellulose fibers can be felt, thus causing a sense of unease in the texture. As a stabilizer or a thickening agent, the applications in which such cellulose can be used are very limited.

Examples of known thickening agents containing microfibrillated cellulose and a polysaccharide include those disclosed in Patent Documents 1 to 3. The effects shown in these documents include “lump prevention” and “effects on intestinal function”, but no mention is made of obtaining a thickening synergistic effect or that the added amount of thickening agent can be reduced by using together with a specific polysaccharide. Further, Patent Documents 4 and 5 describe a composition wherein cellulose nanofibrils obtained from cells comprising about 80% or more of primary wall are blended with other additives. However, the main purposes of the additive blending are only to improve re-dispersibility of a dry product and compensate the function of the cellulose nanofibrils.

Patent Document 6 describes a gel-forming composition containing a water-dispersible dry composition and a polysaccharide. However, the structure of the water-dispersible dry composition described in the Examples of Patent Document 6 only consists of two components, water-dispersible cellulose and the water-soluble polymer sodium carboxymethyl cellulose. If such a water-dispersible dry composition is dispersed in ion exchanged water by a very strong shear force, which would be industrially unrealistic, using a strong apparatus such as an Ace Homogenizer (manufactured by Nippon Seiki, Co., Ltd.), the particles are disintegrated and a fine-fibrous cellulose disperses in the water. However, if dispersed by a shear force under industrially practical dispersion conditions, i.e. in ordinary tap water by a shear force of that from a rotational homogenizer (e.g. “T.K. HOMO MIXER”, manufactured by Primix Corporation) which is generally used in industry, the particles do not sufficiently disintegrate. Thus, since dispersion is not sufficient, performance as a stabilizer, a thickening agent, or a gelling agent cannot be sufficiently exhibited even if used together with a polysaccharide.

Further, in Comparative example 2 of Patent Document 7, it is described that an aqueous dispersion having a 1% by weight solid component consisting of the microfibrillated cellulose of the present application and guar gum adjusted in a 9:1 weight ratio turns into a viscous liquid. However, compared with guar gum, microfibrillated cellulose itself has a high thickening effect. Thus, there is a synergistic effect, but the thickening effect of guar gum about 10% those of microfibrillated cellulose. At that level of thickening effect, in terms of cost the composition is not a desirable substitute material for food items. In addition, since the effect was quite low, at the time it was not known whether there was in fact a synergistic effect. Specifically, the difference was difficult to distinguish by human senses such as vision or the like.

Further, Patent Document 8 describes that a heat resistant gel can be formed by mixing in water a highly dispersible fine-fibrous cellulose complex and a polysaccharide selected from among galactomannan, glucomannan and alginic acid, stirring the resultant solution and then leaving to stand. However, this gelatinous composition is basically composed of just two components, a fine-fibrous cellulose complex and one kind of polysaccharide. With this combination, strength is not sufficient and elasticity is lacking. It is thus hard to say that such composition possesses the physical properties required for general food items, and further, it is impossible to control the physical properties the desired gel.

Further, Patent Document 9 a gelatinous food item which comprises three essential components: denatured emulsified protein fine particles; a composition containing microcrystalline cellulose or microfibrillated cellulose; and a gelling agent for forming the gel. However, this is an effect which only arises by utilizing the heat-coagulating nature of the protein, and the usage conditions are quite limited.

In view of this, the below-described highly dispersible cellulose complex used as a structural component of the composition according to the present invention comprises as essential components water-dispersible cellulose, a waster-soluble polymer and a hydrophilic substance. By comprising all of these three components, particles are disintegrated even under practical dispersion conditions, and good dispersibility is exhibited. As a result, performance as a stabilizer, a thickening agent, or a gelling agent can be sufficiently exhibited when used together with a polysaccharide.

Patent Document 1: Japanese Patent No. 1731182

Patent Document 2: JP-A-60-260517

Patent Document 3: Japanese Patent No. 1850006

Patent Document 4: JP-A-2001-520180

Patent Document 5: Japanese Patent No. 3247391

Patent Document 6: JP-A-2004-41119

Patent Document 7: JP-A-2004-248536

Patent Document 8: JP-A-2006-008857

Patent Document 9: JP-A-2004-344042

### BRIEF SUMMARY OF THE INVENTION

It is an object of the present invention to provide a stabilizer for stable retention and/or immobilization of grains of fruit flesh or the like in food items, and provide a thickening agent capable of imparting viscosity through addition of a small amount thereof. Also provided is a gelling agent which is plant-derived, can provide a gelatinous substance having physical properties which are normally preferred when used in a food item, and can form a heat resistant gel which can maintain commercial value even when subjected to a retort sterilization treatment.

The present invention provides a composition comprising a polysaccharide and a highly dispersible cellulose complex consisting of a water-dispersible cellulose which is a fine-fibrous cellulose made from plant cell walls as a raw material, a water-soluble polymer and a hydrophilic substance. The present invention further provides a stabilizer, thickening and gelling agent comprising the above composition. Specifically, the present invention is as follows.

(1) A composition comprising a highly dispersible cellulose complex and a polysaccharide in a weight ratio of 1:9 to 8:2, wherein the highly dispersible cellulose complex is a dry composition consisting of:

i) 50 to 95% by weight of a water-dispersible cellulose;

ii) 1 to 49% by weight of a water-soluble polymer; and

iii) 1 to 49% by weight of a hydrophilic substance, the water-dispersible cellulose originating from plant cell walls as a raw material and being a fine-fibrous cellulose having a major axis of 0.5 to 30 μm, a minor axis of 2 to 600 nm, and a major axis/minor axis ratio of 20 to 400, the water-dispersible cellulose component comprising 10% by weight or more of a component stably suspensible in water, and having a loss tangent of less than 1 when formed as a 0.5% by weight aqueous dispersion.

(2) The composition according to item 1, wherein the highly dispersible cellulose complex is a dry composition consisting of:

i) 55 to 85% by weight of a water-dispersible cellulose;

ii) 1 to 30% by weight of a water-soluble polymer; and

iii) 5 to 40% by weight of a hydrophilic substance.

(3) The composition according to item 1 having a weight ratio of the water-dispersible cellulose: the total of the water-soluble polymer and the hydrophilic substance: the polysaccharide of 0.5:0.5:9 to 7.6:0.4:2.

(4) The composition according to item 1 having a weight ratio of the water-dispersible cellulose: the total of the water-soluble polymer and the hydrophilic substance: the polysaccharide of 0.55:0.45:9 to 6.8:1.2:2.

(5) A stabilizer for grain immobilizing which comprises the composition according to any one of items 1 to 4, wherein the polysaccharide contains at least one selected from the group consisting of galactomannan, glucomannan, sodium alginate, tamarind seed gum, pectin, carrageenan, gellan gum, agar, sodium carboxymethyl cellulose, soybean water-soluble polysaccharide, karaya gum, psyllium seed gum, pullulan, gum arabic, tragacanth gum, gum ghatti, arabinogalactan and curdlan.

(6) A stabilizer for grain immobilizing which comprises the composition according to any one of items 1 to 4, wherein the polysaccharide contains at least one selected from the group consisting of galactomannan, glucomannan, sodium alginate, tamarind seed gum, gellan gum, sodium carboxymethyl cellulose, soybean water-soluble polysaccharide, karaya gum and gum arabic.

(7) A thickening agent which comprises the composition according to any one of items 1 to 4, wherein the polysaccharide contains at least one selected from the group consisting of galactomannan, glucomannan, sodium alginate, tamarind seed gum, pectin, carrageenan, gellan gum, agar, sodium carboxymethyl cellulose, soybean water-soluble polysaccharide, karaya gum, psyllium seed gum, pullulan, gum arabic, tragacanth gum, gum ghatti, arabinogalactan and curdlan.

(8) A thickening agent which comprises the composition according to any one of items 1 to 4, wherein the polysaccharide contains at least one selected from the group consisting of galactomannan, glucomannan, sodium alginate, tamarind seed gum, gellan gum, sodium carboxymethyl cellulose, soybean water-soluble polysaccharide, karaya gum and gum arabic.

(9) The composition according to any one of items 1 to 4, wherein the water-dispersible cellulose comprises 30% by weight or more of a component stably suspensible in water.

(10) The composition according to any one of items 1 to 3, wherein the composition can easily disperse in an aqueous 0.01% calcium chloride solution.

(11) The composition according to any one of items 1 to 4, wherein the water-dispersible cellulose has a crystallinity exceeding 50%.

(12) The composition according to any one of items 1 to 4, wherein the water-soluble polymer is at least one selected from the group consisting of gum arabic, xanthan gum, sodium carboxymethyl cellulose, gellan gum, and indigestible dextrin.

(13) The composition according to any one of items 1 to 4, wherein the hydrophilic substance is at least one selected from dextrins and trehalose.

(14) A food item comprising the composition according to any one of items 1 to 3, 9 and 10, the stabilizer according to item 5 or 6, or the thickening agent according to item 7 or 8.

(15) A thickening/gelling agent comprising the composition according to any one of items 1 to 4, which comprises the highly dispersible cellulose complex, polysaccharide and xanthan gum, wherein the polysaccharide is at least one selected from the group consisting of galactomannan, glucomannan, sodium alginate and deacetylated gellan gum.

(16) The thickening/gelling agent according to item 15, wherein the polysaccharide is galactomannan or glucomannan.

(17) The thickening/gelling agent according to item 15 or 16, having a weight ratio of the total of the highly dispersible cellulose complex and polysaccharide: xanthan gum of 7:3 to 9.9:0.1.

(18) The thickening/gelling agent according to any one of items 15 to 17, wherein the water-dispersible cellulose comprises 30% by weight or more of a component stably suspensible in water.

(19) The thickening/gelling agent according to any one of items 15 to 17, wherein the composition can easily disperse in an aqueous 0.01% calcium chloride solution.

(20) The thickening/gelling agent according to any one of items 15 to 17, wherein the water-dispersible cellulose has a crystallinity exceeding 50%.

(21) The gelling agent according to any one of items 15 to 20, wherein when formed as a standard gel having a rupture strength of 1.4 N to 1.5 N, rupture strain factor is 33 to 45%, and brittleness strain factor is 1 to 10%.

(22) The gelling agent according to any one of items 15 to 20, wherein when formed as a standard gel having a rupture strength of 1.4 N to 1.5 N, rupture strain factor is 7 to 20%, and brittleness strain factor is 2 to 15%.

(23) A food item comprising the thickening/gelling agent or gelling agent according to any one of items 15 to 22.

(24) A liquid-state composition comprising the composition according to any one of items 1 to 4, 9 and 10 to 13, the stabilizer according to item 5 or 6, the thickening agent according to item 7 or 8, or the thickening/gelling agent according to any one of items 15 to 22.

(25) A gelatinous composition comprising the thickening/gelling agent or gelling agent according to any one of items 15 to 22.

### BRIEF DESCRIPTION OF THE SEVERAL VIEWS OF THE DRAWING

FIG. 1 is a schematic diagram illustrating the way to read rupture strength, rupture deformation and brittleness deformation in the rupture pattern example of a gel.

### DETAILED DESCRIPTION OF THE INVENTION

The present invention will be now be described in detail by especially focusing on preferable embodiments thereof. The water-dispersible cellulose according to the present invention is made from plant cell walls as a raw material. Preferred materials are those that can be acquired as a raw material cheaply and which are capable of being used industrially. Specific example include pulp composed mainly of natural celluloses, such as timber (coniferous trees and broad leaved trees), cotton linter, kenaf, Manila hemp (abacca), sisal hemp, jute, Savaii grass, esparto grass, bagasse, rice plant straw, wheat straw, reed, bamboo and the like. Although raw cotton, papilus grass, beet, paper mulberry, paper bush, gampi, etc., are also usable, their use is sometimes not preferred because these raw materials are difficult to obtain stably, they contain non-cellulose components in a large amount, and they are difficult to handle. When regenerated cellulose is used as a raw material, a sufficient performance is not exhibited, and thus regenerated cellulose is not included as a raw material of the present invention. Preferred specific examples of the raw material include wood pulp, cotton linter pulp, bagasse pulp, wheat straw pulp, rice plant straw pulp, bamboo pulp and the like. Especially preferred are cellulosic substances made from a graminoid starting material. Specific examples are bagasse pulp, wheat straw pulp, rice plant straw pulp and bamboo pulp.

The crystallinity of the fine-fibrous cellulose used in the present invention as measured by X-ray diffraction (Segal method) exceeds 50%, and is preferably 55% or more. Although the highly dispersible cellulose complex used in the present invention contain non-cellulose components, those components are non-crystalline, and are thus counted as non-crystalline.

The water-dispersible cellulose used in the present invention is in a fine-fibrous state. As used in the present application, the term “fine-fibrous” means that length (major axis) is about 0.5 μm to 1 mm, width (minor axis) is about 2 nm to 60 μm, and the ratio of length to width (major axis/minor axis) is about 5 to 400, as observed and measured by an optical microscope and an electron microscope.

The water-dispersible cellulose or highly dispersible cellulose complex of the present invention contains a component stably suspensible in water. The term “component stably suspensible in water” specifically means a component which is stably suspended in water without sedimentation, even when it is made into an aqueous dispersion having a concentration of 0.1% by weight and the resulting dispersion is centrifuged at 1,000 G for 5 minutes. Such a component is composed of a fibrous cellulose having a length (major axis) of 0.5 to 30 μm and a width (minor axis) of 2 to 600 nm, and a length/width ratio (major axis/minor axis) of 20 to 400, as observed and measured by a high-resolution scanning electron microscope (SEM). The width is preferably 100 nm or less, and more preferably, 50 nm or less.

The water-dispersible cellulose or highly dispersible cellulose complex used as a structural component of the composition according to the present invention contains the “component stably suspensible in water” in an amount of 30% by weight or more. If the content of this component is less than 30% by weight, the above-described functions are not exhibited sufficiently. The higher the content of the “component stably suspensible in water”, the better. It is, however, more preferable that the content is 50% by weight or more. Unless stated otherwise, the content of this component is expressed as a percentage of the amount present in all of the cellulose. Even if the water-soluble component is contained, the content is measured and calculated so that this component is not included.

The water-dispersible cellulose or highly dispersible cellulose complex used as a structural component of the composition according to the present invention exhibits, when made into an aqueous dispersion having a concentration of 0.5% by weight, a loss tangent (tan δ) of less than 1 and preferably less than 0.6, as measured at a strain 10% and frequency 10 rad/s. If the loss tangent is less than 0.6, the performance of the composition becomes even better. If the loss tangent is 1 or higher, the below-described viscosity thickening and gel forming function cannot be sufficiently expressed.

In order for the water-dispersible cellulose or highly dispersible cellulose complex used as a structural component of the composition to exhibit a loss tangent (tan δ) of less than 1, it is necessary to remove the microfibrils which are derived from plant cell walls without cutting them shorter. However, with current technology, it is impossible to only carry out “[miniaturization] ” without also shortening the fibers (here, “shortening the fibers” refers to where the fibers have been cut shorter, or the state where the fibers have become shorter; and “miniaturization” refers to where the fibers have become finer by imparting a tearing-apart or similar effect, or the state where the fibers have become finer). In other words, to make the loss tangent (tan δ) less than 1, it is important to proceed with “miniaturization” while suppressing as much as possible the shortening of the fibers. A preferable method for achieving this will be described below, although the present invention is not limited to that method.

To proceed with “miniaturization” while suppressing as much as possible the shortening of the cellulose fibers, the cellulosic substance using plant cell walls as a starting material selected as the raw material preferably has an average degree of polymerization of 400 to 12,000 and a α-cellulose content (%) of 60 to 100% by weight, and more preferably, 65 to 98% by weight.

An apparatuses used to proceed with “miniaturization” while suppressing as much as possible the shortening of the cellulose fibers is preferably a high-pressure homogenizer. Specific examples of high-pressure homogenizers include “EmulsiFlex” (manufactured by Avestin Inc.), “Ultimizer System” (manufactured by Sugino Machine, Co., Ltd.), “Nanomizer System” (manufactured by Nanomizer Co., Ltd.), “Microfluidizer” (manufactured by MFIC Corp.), and bubble type homogenizers (manufactured by Sanwa Kikai Co., Ltd., Invensys APV Co., Niro Soavi S.p.A., and Izumi Food Machinery Co., Ltd.). The high-pressure homogenizer treatment pressure is preferably 30 MPa or more, and more preferably, 60 to 414 MPa.

The polysaccharide used in the present invention is at least one selected from the group consisting of galactomannan, glucomannan, sodium alginate, tamarind seed gum, pectin, carrageenan, gellan gum, agar, sodium carboxymethyl cellulose, soybean water-soluble polysaccharide, karaya gum, psyllium seed gum, pullulan, gum arabic, tragacanth gum, gum ghatti, arabinogalactan and curdlan. Preferably, the polysaccharide is at least one selected from the group consisting of tamarind seed gum, pectin, carrageenan, sodium carboxymethyl cellulose, soybean water-soluble polysaccharide and karaya gum. The polysaccharide used in the present invention is preferably galactomannan, glucomannan, sodium alginate, tamarind seed gum, gellan gum, sodium carboxymethyl cellulose, soybean water-soluble polysaccharide, karaya gum or gum arabic, and more preferably galactomannan, glucomannan, pectin or sodium carboxymethyl cellulose. It is even more preferable if the carrageenan is lambda-carrageenan.

The galactomannan used in the present invention is a polysaccharide having a structure which is composed of a main chain consisting of β-1,4-bonded β-D-mannose and side chains consisting of α-1,6-bonded α-D-galactose. Examples of galactomannans include guar gum, locust bean gum, tara gum and the like, wherein the proportions of mannose to glucose are about 2:1 for guar gum, about 4:1 for locust bean gum, and about 3:1 for tara gum.

The glucomannan used in the present invention is a polysaccharide having a structure which is composed of β-1,4-bonded D-glucose and D-mannose, wherein the proportions of glucose to mannose are about 2:3. Since galactomannans have a unique pungent odor if their degree of refining is low, it is preferable to use a highly refined product. Depending on the application, konjac powder or konjac mannan may also be used.

The “alginic acid” used in the present invention refers to alginic acid, salts thereof such as sodium alginate, and propyleneglycol alginate. Among these examples, it is preferable to use sodium alginate, which is a water-soluble polysaccharide in which the alginic acid has been neutralized with sodium. Alginic acid is a 1,4-bonding block copolymer consisting of β-D-mannuronic acid (abbreviated to M) and α-L-glucuronic acid (abbreviated to G). Alginic acid is constituted of three segments, i.e. a block consisting of M (M-M-M-M), a block consisting of G (G-G-G-G), and a block consisting of an alternating combination of both residues (M-G-M-G). These alginic acids may be used by controlling pH control and salt concentration.

The pectin used in the present invention has been partially esterified by methanol and has a main chain consisting of α-1,4-bonded α-D-galacturonic acid. By introducing β-L-rhamnose on the galacturonic acid main chain, kinks are formed in the molecule. In some cases a neutral araban, galactan, xylan or the like are linked to the galacturonic acid main chain as side chains or mixed with the pectin. The galacturonic acid constituting the pectin exists in methyl ester form and in the two forms of the acid. The ratio of the galacturonic acid existing in the ester form is known as the degree of esterification. If the degree of esterification is 50% or higher, the pectin is referred to as HM pectin, and if the degree of esterification is less than 50%, the pectin is referred to as LM pectin.

The gellan gum used in the present invention has four sugars, which are glucose, glucuronic acid, glucose and L-rhamnose, linked in a straight chain as a recurring unit. Native gellan gum consists of 3 to 5% acetyl groups linked to the C-6 position of the glucose and glyceryl groups linked to the C-2 position. Deacetylated gellan gum is a gum wherein native gellan gum was subjected to a deacetylation treatment and then purified. The sodium carboxymethyl cellulose used in the present invention has had the hydroxyl groups of the cellulose esterified by monochloroacetatic acid or sodium monochloroacetate and has a β-1,4-bonded D-glucose straight chain structure.

The soybean water-soluble polysaccharide used in the present invention is composed of sugars such as galactose, arabinose, galacturonic acid, rhamnose, xylose and glucose. It is thought that galactan and arabinan are linked to the rhamnogalacturonic acid chain.

The molecular structure of the gum arabic used in the present invention is not clearly understood. However, the its structural sugars are reported to be D-galactose 36%, L-arabinose 31%, L-rhamnose 13%, and D-glucuronic acid 18%, and to also have 2% of protein.

The xanthan gum used as the third component of the thickening/gelling agent or gelling agent according to the present invention has a structure which is composed of a main chain consisting of β-1,4-bonded D-glucose and side chains consisting of D-mannose, D-glucuronic acid and D-mannose bonded to the anhydroglucose of the main chain. Position 6 of the D-mannose attached to the main chain is acetylated, and the end D-mannose has a structure having many branches having acetyl linkages to pyruvic acid.

The thickening/gelling agent manifests a synergistic effect through the combined use of the highly dispersible cellulose complex serving as the first component of the present invention, the polysaccharide serving as the second component and xanthan gum serving as the third component, which results in an unexpectedly large improvement in viscosity or gel rupture strength. Although the reason for this large improvement in viscosity or gel rupture strength is not clear, from the fact that no synergistic effects are seen if just the highly dispersible cellulose complex serving as the first component and xanthan gum serving as the third component are mixed together, it can be considered that the large improvement in thickening/gelling agent viscosity or gel rupture strength is as a result of the linkages between the first component and the second component, and those between the second component and the third component, being used in a synergistic manner.

In addition, with the gelling agent according to the present invention, it is possible to control the physical properties of the gel having a below-described rupture strain factor and brittleness strain factor by adding a small amount of xanthan gum, which by itself does not turn into a gel.

In addition to these components, the stabilizer, thickening and thickening/gelling agent according to the present invention may also be appropriately blended with a starch, an oil or a fat, a protein, a peptide, an amino acid, a salt such as a dietary salt and various phosphoric acid salts, a surfactant, an emulsifier, a preservative, a pot-life improver, a souring agent, a sweetener, an incense, a colorant, a pH adjuster, a defoaming agent, a mineral, dietary fiber, a flavoring, an acid, an alkali, an alcohol and the like.

The highly dispersible cellulose complex used as a structural component of the stabilizer, thickening and thickening/gelling agent composition according to the present invention consists of 50 to 95% by weight of water-dispersible cellulose, 1 to 49% by weight of water-soluble polymer, and 1 to 49% by weight of hydrophilic substance. Preferably, the highly dispersible cellulose complex is a dry composition composed of water-dispersible cellulose:water-soluble polymer:hydrophilic substance in the range of 55 to 85:1 to 30:5 to 40% by weight, and more preferably, 60 to 75:5 to 20:15 to 25% by weight. This composition may be granular, particulate, powdery, scaly, crumbly or sheet-shaped. When this complex is charged into water and subjected to a mechanical shearing force, the composition is characterized in that the particles disintegrate so that fine-fibrous cellulose disperses in the water. If the water-dispersible cellulose is less than 50% by weight, the ratio of cellulose is low, whereby the effects are not exhibited.

The weight ratio of xanthan gum serving as the third component which is further added to the above-described first and second components is preferably: ratio of first component (highly dispersible cellulose complex) plus second component (polysaccharide) to third component is 7:3 to 9.9:0.1, and more preferably, 8.5:1.5 to 9.8:0.2.

The water-soluble polymer which is a component of the highly dispersible cellulose complex used in the present invention is a substance that acts to prevent keratinization among the cellulose during drying. Specific examples of the compounds used include one or two or more substances selected from gum arabic, arabinogalactan, alginic acid and salts thereof, curdlan, gum ghatti, carrageenan, karaya gum, agar, xanthan gum, guar gum, enzymatically-hydrolyzed guar gum, quince seed gum, gellan gum, gelatin, tamarind seed gum, indigestible dextrin, tragacanth gum, furcellaran, pullulan, pectin, locust bean gum, water-soluble soybean polysaccharide, sodium carboxymethyl cellulose, methylcellulose and sodium polyacrylate. Among these substances, preferable are gum arabic, xanthan gum, sodium carboxymethyl cellulose, gellan gum and indigestible dextrin. More preferable is sodium carboxymethyl cellulose. As the sodium carboxymethyl cellulose, even more preferable is cellulose having a carboxymethyl group degree of substitution of 0.5 to 1.5, preferably 0.5 to 1.0, and more preferably, 0.6 to 0.8. In addition, when made into a 1% by weight aqueous solution, the viscosity should be about 5 to 9,000 mPa·s, preferably about 1,000 to 8,000 mPa·s, and more preferably, about 2,000 to 6,000 mPa·s.

The hydrophilic substance which is a component of the highly dispersible cellulose complex used in the present invention is a substance having a high solubility in cold water which is hardly viscous and is a solid at room temperature. Examples of the hydrophilic substance include one, or two or more, substances selected from dextrins, water-soluble sugars (glucose, fructose, sucrose, lactose, isomerized sugar, oligosaccharide, xylose, trehalose, coupling sugar, paratinose, sorbose, reduced starch-saccharified gluten, maltose, lactulose, fructo-oligosaccharide, galacto-oligosaccharide), and sugar alcohols (xylitol, maltitol, mannitol, sorbitol, etc.). Preferable are dextrins and trehalose, and more preferable are dextrins. As mentioned above, the water-soluble polymer acts to prevent the keratinization of cellulose. Nevertheless, some water-soluble polymers are inferior in water-conveying property into the complex interior. Accordingly, it is sometimes necessary to apply a stronger mechanical shearing force for a longer period of time. The hydrophilic substance mainly enhances the water-conveying property, and specifically, accelerates the water-disintegrating property of the dry composition.

The dextrins used in the present invention are partial hydrolyzates formed by hydrolyzing starch by an acid, an enzyme or heat, in which the glucose residues are combined through α-1,4 linkages and α-1,6 linkages. As expressed in terms of DE (dextrose equivalent), those having a DE value of about 2 to 42, and preferably, about 20 to 42, are used. Branched dextrin from which glucose and low molecular weight oligosaccharide have been removed can also be used.

The trehalose used in the present invention is a disaccharide to which two D-glucose molecules are linked. These linkages are usually α, α (1→1) linkages.

As mentioned above, when the highly dispersible cellulose complex of the present invention is charged into water and a mechanical shearing force is applied thereto, the constitutional units (such as the particles) are disintegrated and the fine-fibrous cellulose is dispersed in water. This “mechanical shearing force” refers to dispersing a 0.5% by weight aqueous dispersion with a rotational homogenizer at 15,000 rpm or less for 15 minutes at temperature of 80° C. or lower.

The thus-obtained aqueous dispersion contains in a state prior to drying the “component stably suspensible in water” in an amount of 30% by weight or more based on the total cellulose component. This aqueous dispersion has a loss tangent smaller than 1, at a concentration of 0.5% by weight. The conditions for measuring the content of the “component stably suspensible in water” in the water-dispersible cellulose and the loss tangent will be described later. As described above, the water-dispersible cellulose has a major axis of 0.5 to 30 μm and a minor axis of 2 to 600 nm. The major axis/minor axis ratio is 20 to 400. Preferably, the width thereof is 100 nm or less, and more preferably 50 nm or less.

The weight ratio between the water-dispersible cellulose and the polysaccharide which constitute the stabilizer thickening and thickening/gelling agent of the present invention is, as solid content, 1:9 to 8:2, preferably, 2:8 to 7:3, and more preferably, 4:6 to 6:4.

If the highly dispersible cellulose complex according to the present invention is stirred in a 0.01% by weight aqueous calcium chloride solution, the particles are easily disintegrated and dispersed, whereby a high viscosity is expressed. The extent of this is such that viscosity when stirred under practical conditions in a 0.01% by weight aqueous calcium chloride solution is 50% or more as compared with the viscosity exhibited when stirred by a strong force in pure water.

In a 0.01% aqueous calcium chloride solution, the value expressed as “hardness” of ordinary tap water is 90, which is the maximum level ion concentration of ordinary tap water in Japan. It is known that such an ion presence will have an effect on swelling and solubility of a water-soluble polymer, such as sodium carboxymethyl cellulose, whereby the ability to promote integrating and dispersion of the particles is dramatically decreased. As a result, when used in many food items, such as dressings and foods formulated with milk, it is necessary to either pre-disperse in pure water, or use a strong dispersing machine such as a high-pressure homogenizer. This is a problem.

The structural viscosity formation effect of the present invention is expressed as a structural viscosity index (TI value) calculated from the “viscosity at a rotation speed of 3 rpm (η3)” and “viscosity at a rotation speed of 100 rpm (η100)”. Stability tends to depend on η3, and thus structural viscosity index (TI value) is compared using aqueous dispersions (or liquid-state compositions) which have been adjusted so that their η3 express about the same viscosity. The term “TI value” used here is represented by “TI=η3/η100”, wherein the higher the TI value, the better liquid drainability is and the lower the sense of pasty feeling is. A structural viscosity formation effect is considered to exist when the following structural viscosity index is such that “TIα>TIβ”.

The structural viscosity index (TIα) of the aqueous dispersion of the composition according to the present invention is determined from “TIα=η3α/η100 α”.

η3α: Viscosity of an aqueous dispersion of the composition according to the present invention at 3 rpm.

η100α: Viscosity of an aqueous dispersion of the composition according to the present invention at 100 rpm.

The structural viscosity index (TIβ) of the aqueous dispersion of the polysaccharide contained in the composition according to the present invention used in the adjustment of the viscosities η3α and η100α can be determined from “TIβ=η3β/η100 β”.

η3β: Viscosity at 3 rpm of an aqueous dispersion of the polysaccharide contained in the composition according to the present invention used in the adjustment of the viscosity η3α.

(however, the added amount of polysaccharide is adjusted so that η3β≈η3α; i.e. “0.9≦η3α/η3β≦1.1”.)

η100β: Viscosity at 100 rpm of an aqueous dispersion of the polysaccharide contained in the composition according to the present invention used in the adjustment of the viscosity η100α.

The term “liquid drainability” as used here refers to the draining behaviour when the aqueous dispersion is shifted from the vessel. Specifically, when a vessel is tilted and then returned to its original position, if liquid drainability is good, not much liquid adheres to the lip vicinity of the vessel. However, if liquid drainability is poor, a large amount of liquid adheres to the lip vicinity of the vessel, and if liquid drainability is even poorer, the liquid forms threads which do not break.

The gelling agent according to the present invention is preferably such that when used to form a standard gel (rupture strength of 1.4 N to 1.5 N at 5° C.), rupture strain factor is 33 to 45%, and brittleness strain factor is 1 to 10%. A gel which manifests these kind of physical properties is a gel which exhibits gelatin-like physical properties, and thus such a gel can provide more preferable physical properties for a general food item. To achieve this, the polysaccharide serving as the third component is preferably selected from among glucomannan and galactomannan. If galactomannan is used, it is preferable to select locust bean gum. To exhibit even more preferable gelatin-like physical properties, a more preferable rupture strain factor of the standard gel is 36 to 42%.

Further, the gelling agent may also be preferably such that when used to form the above-described standard gel, rupture strain factor is 7 to 20%, and brittleness strain factor is 2 to 15%. A gel which manifests these kind of physical properties is a gel which exhibits agar-like physical properties, and thus such a gel can provide more preferable physical properties for a general food item. To achieve this, the polysaccharide serving as the third component is preferably used by first using deacylated gellan gum and then selecting from among glucomannan and galactomannan. If galactomannan is used, it is preferable to select locust bean gum. To exhibit even more preferable agar-like physical properties, a more preferable rupture strain factor of the standard gel is 13 to 18%.

The term “sense of pasty feeling” used in the present invention refers to a sense of pasty feeling or sliminess felt when a person puts the liquid in their mouth. This is generally comparable to a viscosity having a shear rate of 10 to 50/s. It is said that the higher this viscosity is, the stronger the sense of pasty feeling is. If the rotation speed (rpm) for a B type viscometer is calculated as shear rate (/s), 100 rpm is comparable to about 20 to 70/s. Thus, the lower that η100 is, and since in the present invention η3β≈η3α, the greater that the structural viscosity index (TI value) is, the sense of pasty feeling is not felt as much.

The stabilizer, thickening agent and thickening/gelling agent according to the present invention may be made into a liquid-state composition by mixing as an aqueous solution or a paste mainly dissolved in water into other food items, medical or pharmaceutical products, industrial articles and the like. Specifically, the term “liquid-state composition” refers to a state that is a liquid or a paste at room temperature, and as such includes liquid-state food item compositions, liquid-state cosmetic compositions, liquid-state medical or pharmaceutical product compositions, liquid-state industrial article compositions and the like. These liquid-state compositions may be used in solid form after being cooled, frozen or dry. The added amount of the composition blended into these liquid-state compositions is not especially limited, but is normally about 0.001 to 2% by weight, and preferably, about 0.1 to 1% by weight.

Examples of liquid-state food item compositions include: luxury drinks, such as coffee, teas such as black tea, Japanese tea, oolong tea, and barley tea, green powdered tea, cocoa, sweet bean paste soup, juice, soybean juice and the like; milk component-containing drinks, such as raw milk, processed milk, fermented milk drinks, lactic acid drinks and the like; fermented milk (including drinks added with calcium, juice or the like); Japanese confectioneries such as red bean soup with pieces of rice cake, sweet bean paste; various drinks including nutrition-enriched drinks, such as calcium-fortified drinks and the like and dietary fiber-containing drinks and the like; dairy products, such as coffee whitener, whipping cream, custard cream, soft cream and the like; cakes; butter mix; shortenings; soups; stews; seasonings such as sauces, dressings and the like; various paste condiments represented by kneaded mustard; fruit flesh or vegetable processed items represented by fruit sauces, fruit preparations and jams; liquid foods such as tube-fed liquid food and the like; and liquid or paste health food products; liquid or paste pet food products. These examples may be different in their form or processing operation at the time of preparation, as seen in retort foods, frozen foods, microwave foods and the like. These liquid-state compositions may be used in solid form after being cooled, frozen or dry.

Examples of liquid-state medical or pharmaceutical product compositions include: oral medicines such as syrup drugs, vitamin drugs, revitalizing drugs and the like; nasally-fed medicines such as hormones; drip or tube-fed medicines such as intravenous fluids, anticancer drugs, chemotherapy drugs and the like; enteral medicine; drug carriers; DNA carriers; biomaterials such as artificial cartilage, biomedical adhesives and the like; liquid foods such as tube-fed liquid food classified as medicines; quasi-drugs such as medicinal cosmetics, vitamin-containing healthcare products, hair preparations, medicinal toothpastes, bath preparations, insecticides, underarm deodorants, mouth fresheners and the like; compresses; coatings and the like.

Examples of liquid-state cosmetic compositions include: skin care cosmetics such as cleansing cosmetics, milky lotions, essences, packs, moisture creams, foundations, weightage creams, cold creams, cleansing creams, face washes, vanishing creams, emollient creams, hand creams, sun block preparations and the like; makeup cosmetics such as foundation, lipsticks, lip creams, cheek powder, sunscreen preparations, eyebrow pencils, eyelash cosmetics such as mascara, nail cosmetics such as nail polishes and nail polish removers; hair cosmetics such as shampoos, conditioners, hair tonics, hair treatments, hair oil, ticks, hair cream, balms, grooming preparations, hair styling products, hair sprays, hair dyes, hair growth lotions and tonics; as well as detergents such as hand cleaners, bath cosmetics, shaving cosmetics, air fresheners, toothpastes, ointments and compresses.

Examples of liquid-state industrial compositions include: pigments, coating compositions, inks, toiletry products such as deodorizers, air fresheners, antibacterial/antimildew agents, hygienic goods, toothpastes and the like, adhesives, coating agents, surfactants, culture materials, detergents, liquid soaps, liquid fuels, antifreeze and the like.

The gelatinous composition according to the present invention has a large rupture strength just by using a comparatively small amount of thickening/gelling agent, and has excellent heat resistance. For this reason, the gelatinous composition can be utilized not only in food item applications, but also in medical or pharmaceutical products, cosmetics and industrial article applications. These gelatinous compositions may also be used in solid form after being cooled, frozen or dry. Further, the temperature for heated sterilization when the gelatinous composition is used in a food item or the like is preferably 80° C., more preferably, 105 to 150° C., and even more preferably, 105 to 121° C. A rough target for the heating time is, at 80° C., 1 to 3 hours, and at 105° C. or more, 30 minutes.

Examples of gelatinous compositions include: deserts such as puddings, jelly and the like; yoghurts such as fruit yoghurts, nutritionally fortified yoghurts (such as Ca-fortified or the like); iced deserts such as ice cream, soft cream, sherbets and the like; ingredients added as an accent into drinks, such as mitsuame, yoghurt and the like; Japanese confectioneries such as bean jam buns, kuzukiri, soft adzuki-bean jelly, candies; confectioneries such as jelly candies, candies, caramel, gum, chocolates and the like; baked goods such as cookies, biscuits, rice crackers and the like; filings; butter mixes; shortenings; universal design foods such as foods for people who have difficult swallowing, nursing care foods, cut-up foods, thickened foods and the like; gelatinous drinks; seasonings such as sauces, bastes (tare), dressings, mayonnaise and the like; various paste condiments represented by kneaded mustard; noodles; gyoza, spring rolls and Chinese manju; fruit flesh or vegetable processed items represented by fruit sauces, fruit preparations and jams; liquid foods such as tube-fed liquid food classified as food items; health food products and nutritionally fortified food items; gelatinous food items such as steamed hotchpotch, tofu and the like; kneaded products such fish sausage; processed meats such as sausages, hams and the like; milk products such as spreads, cheeses, whipped cream and the like; daily dishes, boxed lunches and the like; gel products which are ingested as a typical drinks (such as coffee, teas, isotonic drinks, milk, milky drinks, acidic milky drinks, soybean milk, soybean drinks, green powdered tea, cocoa, shiruko, juices, drinks containing fruit flesh and the like); pet foods and the like. These examples may be different in their form or processing operation at the time of preparation, as seen in retort foods, frozen foods, microwave foods and the like.

In addition to the above-described food item applications, by using the thickening/gelling agent novel food item forms can be provided which are not currently commonly in circulation. Examples of novel food item forms include “novel allergen-free food items” such as steamed hotchpotch, puddings and mayonnaise in which the thickening/gelling agent is used in place of eggs; “novel low calorie food items” such as porridge-like food items in which the thickening/gelling agent is used in place of rice; and include “food substitute chewable packs” which can be ingested by making a soup or miso soup into a gel and then warming up.

Examples of gelatinous medical or pharmaceutical product compositions include: oral medicines; nasally-fed medicines such as hormones; medicines such as enteral medicines, dermatological medicines and medicines delivered through the skin; contrast agents; liquid foods such as tube-fed liquid food classified as medicines; quasi-drugs such as medicinal cosmetics, vitamin-containing healthcare products, hair preparations, medicinal toothpastes, bath preparations, insecticides, underarm deodorants, mouth fresheners and the like; biomaterials such as artificial cartilage, biomedical adhesives, wound dressings, artificial organs and the like; compresses; coatings and the like.

Examples of gelatinous cosmetic compositions include: skin care cosmetics such as gelatinous cosmetics containing a beauty component, packs, moisture creams, weightage creams, cold creams, cleansing creams, face washes, vanishing creams, emollient creams, hand creams, sun block preparations and the like; makeup cosmetics such as foundation, lipsticks, lip creams, cheek powder, sunscreen preparations, eyebrow pencils, eyelash cosmetics such as mascara, nail cosmetics such as nail polishes and nail polish removers; hair cosmetics such as shampoos, conditioners, hair treatments, hair oil, stick, hair cream, balms, grooming preparations, hair styling products, hair sprays, hair dyes, hair growth lotions and tonics; as well as detergents such as hand cleaners, bath cosmetics, shaving cosmetics, air fresheners, toothpastes, ointments and compresses.

Examples of gelatinous industrial product compositions include: pigments, coating compositions, inks, deodorizers, air fresheners, antibacterial/antimildew agents, adhesives, coating agents, surfactants, hygienic goods such as paper diapers, culture materials such as cells, viruses and the like, experiment materials such as electrocataphoretic gels, chromatography columns, or the filling agents thereof, agricultural or gardening products such as soil improvement agents, plant cultivation water retention agents and the like, artificial snow, filtering agents, liquid soap, gunpowder, explosives, cartilage, compresses and the like.

In addition to adding the stabilizer, thickening agent and thickening/gelling agent according to the present invention to water, the following components may be also be blended into the liquid-state composition and gelatinous composition. Examples include: food item materials (mined meat, fish meat, beans, grains and crushed powder thereof, milk/milk products, fermented milk, vegetables, fruit, fruit juice, food oils and the like), luxury drinks (coffee, teas, juice, milk drinks and soybean milk), seasonings (miso, soy sauce, sugar, salt, sodium glutamate and the like), sweeteners, sugars, sugar alcohols, flavoring agents, dyes, condiments, souring agents, emulsifiers, surfactants, preservatives, pot-life improvers, disinfectants, disintegrating agents, defoaming agents, foaming agents, pH adjusters, thickening/stabilizers, food fiber, fortifying agents (vitamins, minerals, amino acids and the like), extracts, protein, starch, peptides, alcohols, organic solvents, plasticizers, oils, buffer solutions, fuels, gunpowder, explosives, acids, alkalis, ionic substances, microcapsules, beauty components (whitening components, moisturizing components and the like), hygienic substances, components having a medicinal effect, medicine additives, pesticides, fertilizers, deodorants, insecticides, metals, catalysts, ceramics, coating compositions, inks, pigments, polishing agents, synthetic polymers (plastics, rubber, synthetic fibers and the like), naturally-derived polymers, (collagen, hyaluronic acid, natural fibers and the like), paper and the like. These examples may be different in their form or processing operation at the time of preparation, as seen in retort foods, frozen foods, microwave foods and the like.

These liquid food compositions and gelatinous food item compositions are normally supplied at a pH of 3 to 8 and a dietary salt concentration of 0.001 to 20%. The stabilizer, thickening agent and thickening/gelling agent according to the present invention exhibit good effects under such conditions.

The term “gelation” as used in the present invention refers to the capability a so-called “true gel” similar to a jelly or a pudding being formed when the aqueous dispersion is left to stand. The determination is made 24 hours after being left to stand. Further, the gelated aqueous dispersion does not have any fluid properties.

Next, the present invention will be described in more detail by referring to the Examples. The physical properties of the substances of the present invention were evaluated according to the following methods.

<Crystallinity of the Cellulosic Substance>

Crystallinity is defined according to the following formula as calculated by the Segal method from diffraction intensity values of the X-ray diffraction patterns measured using an X-ray diffraction as prescribed in JIS K 0131-1996 (“X-ray diffraction analysis general procedures”).
Crystallinity (%)={(Ic−Ia)/Ic}×100

Here, Ic represents the diffraction intensity where the diffraction angle 2θ of the X-ray diffraction pattern is 22.5 degrees; and Ia represents the baseline intensity (minimum value) where the same diffraction angle 2θ is approximately 18.5 degrees

<Shape (Major Axis, Minor Axis, Major Axis/Minor Axis Ratio) of Cellulose Fiber (Particles)>

Since the sizes of cellulose fibers (particles) vary in a wide range, it is impossible to observe all of the fibers with only one kind of microscope. Accordingly, an optical microscope and a scanning microscope (medium resolution SEM and high resolution SEM) are appropriately selected according to the size of the fiber (particle) to carry out observation and measurement. When an optical microscope is used, a sample and water are weighed out so that the aqueous dispersion has a solid concentration of 0.25% by weight. This dispersion is dispersed using an “Excel Auto Homogenizer” (manufactured by Nippon Seiki, Co., Ltd.) at 15,000 rpm for 15 minutes, and the resultant dispersion is adjusted to an appropriate concentration and is then put on a slide glass, covered with a cover glass, and observed. When a medium resolution SEM (JSM-5510LV, manufactured by JEOL Ltd.) is used, an aqueous sample dispersion is put on a sample stand and air dried, after which about 3 nm of Pt—Pd is vapor-deposited thereon and the sample is then observed. When a high resolution SEM (S-5000, manufactured by Hitachi Science Systems, Co., Ltd.) is used, a sample aqueous dispersion is put on a sample stand and air-dried, after which about 1.5 nm of Pt—Pd is vapor-deposited thereon and the sample is then observed.

The major axis, minor axis and major axis/minor axis ratio of the cellulose fibers (particles) were measured for 15 or more fibers from photographs. The fibers ranged from nearly straight ones to curved ones (like a hair), but none of the fibers was in curled form like waste yarn. The minor axis (thickness) varied even within a single fiber, and thus the average value was taken. The high resolution SEM was used for observation of fibers having a minor axis of about several nm to 200 nm, but one fiber was too long and could not be observed in a single visual field. Thus, photographing was repeated while moving the visual field, after which the photographs were combined and analyzed.

<Content of “Component Stably Suspensible in Water”>

The content was determined from the following (1) to (5) and (3′) to (5′).

(1) A sample and pure water were weighed out so as to give an aqueous dispersion with a cellulose concentration of 0.1% by weight, and dispersed with an Ace Homogenizer (Model AM-T, manufactured by Nippon Seiki, Co., Ltd.) at 15,000 rpm for 15 minutes.

(2) 20 g of the sample solution was introduced into a centrifugal tube and centrifuged with a centrifugal machine at 1,000 G for 5 minutes.

(3) The upper liquid layer was removed, and the weight of the sedimented component (a) was measured.

(4) Then, the sedimented component was completely dried, and the weight of the solid component (b) was measured.

(5) According to the following formula, the content of the “component stably suspensible in water” (c) was calculated:
c=5,000×(k1+k2) [% by weight]

k1 and k2 were calculated according to the following formulae. (Here, “k1” represents the amount of “fine-fibrous cellulose” in the upper layer of the liquid; “k2” represents the amount of “fine-fibrous cellulose” in the sedimented component; “w1” represents the amount of water in the upper layer of the liquid; “w2” represents the amount of water in the sedimented component; and “s2” represents the amount of “water-soluble polymer+hydrophilic substance” in the sedimented component.)
k1=0.02−b+s2
k2=k1×w2/w1
(water-soluble polymer+hydrophilic substance)/cellulose=d/f (compounding ratio)
w1=19.98−a+b−0.02×d/f
w2=a−b
s2=0.02×d×w2/{f×(w1+w2)}

When the content of the “component stably dispersible in water” was very large, the weight of the sedimented component was small, and therefore the accuracy of measurement according to the above-described method decreased. In such cases, therefore, the following procedures were carried out after (3).

(3′) The upper liquid layer was taken out and the weight (a′) was measured.

(4′) Then, the upper layer component was completely dried and the weight of the solid component (b′) was measured.

(5′) According to the following formula, the content of the “component stably dispersible in water” (c) was calculated:
c=5,000×(k1+k2) [% by weight]

k1 and k2 were calculated according to the following formulae. (Here, “k1” represents the amount of “fine-fibrous cellulose” in the upper layer of the liquid; “k2” represents the amount of “fine-fibrous cellulose” in the sedimented component; “w1” represents the amount of water in the upper layer of the liquid; “w2” represents the amount of water in the sedimented component; and “s2” represents the amount of “water-soluble polymer+hydrophilic substance” in the sedimented component.)
k1=b′−s2×w1/w2
k2=k1×w2/w1
(water-soluble polymer+hydrophilic substance)/cellulose=d/f (compounding ratio)
w1=a′−b′
w2=19.98−a′+b′−0.02×d/f
s2=0.02×d×w2/{f×(w1+w2)}

If in the operation of (3) the boundary between the upper layer of the liquid and the sedimented component was not clear and separation was difficult, the operation was carried out at an appropriately lowered concentration of cellulose.

<Loss Tangent>(=Loss Elastic Modulus/Storage Elastic Modulus)

The loss tangent was determined according to the following procedure.

(1) A sample and pure water were weighed out so as to give an aqueous dispersion having a solid concentration of 0.5% by weight, and dispersed with an Excel Auto Homogenizer (manufactured by Nippon Seiki, Co., Ltd.) at 15,000 rpm for 15 minutes.

(2) The dispersion was left standing in an atmosphere of 25° C. for 3 hours.

(3) The sample solution was introduced into a dynamic viscoelasticity measuring apparatus and left to stand for 5 minutes, and then measured under the following conditions. From the results, a loss tangent (tan δ) at a frequency of 10 rad/s was determined.

Apparatus: ARES (Model 100 FRTN1) (manufactured by Rheometric Scientific Inc.)

Geometry: Double Wall Couette

Temperature: 25° C.

Strain: 10% (fixed)

Frequency: 1 to 100 rad/s (elevated over a period of about 170 seconds)

<Dispersibility of 0.01% Calcium Chloride Aqueous Solution>

(1) A sample and pure water were weighed out so as to give an aqueous dispersion having a solid concentration of 0.25% by weight, and dispersed with an Ace Homogenizer™ (manufactured by Nippon Seiki, Co., Ltd., model AM-T) at 15,000 rpm for 15 minutes (25° C.).

(2) The dispersion was left to stand at 25° C. for 3 hours.

(3) After thoroughly stirring, a rotational viscometer (B type viscometer, manufactured by Tokimec, Inc.) was set up. Thirty seconds after completing the stirring, rotation of the rotor was started. Thirty seconds thereafter, the indication of the viscometer was read, from which viscosity (Va) was calculated. The rotor rotation speed and type were altered appropriately, depending on the viscosity.

(4) Next, a sample, calcium chloride and pure water were weighed out so as to give an aqueous dispersion having a solid concentration of 1% by weight and a calcium chloride concentration of 0.01% by weight, and dispersed with a T.K. HOMO MIXER™ (manufactured by Primix Corporation, Mark II Model 2.5) at 8,000 rpm for 10 minutes (25° C.).

(5) The dispersion was left to stand at 25° C. for 3 hours.

(6) After thoroughly stirring, a rotational viscometer (B type viscometer, manufactured by Tokimec, Inc.) was set up. Thirty seconds after completing the stirring, rotation of the rotor was started. Thirty seconds thereafter, the indication of the viscometer was read, from which viscosity (Vb) was calculated. The rotor rotation speed was set at 60 rpm, and the rotor type was altered appropriately, depending on the viscosity.

(7) The “dispersibility of 0.01% calcium chloride aqueous solution” was calculated using the following formula.
dispersibility of a 0.01% calcium chloride aqueous solution [%]=(Vb/Va)×100
<Preparation of Aqueous Dispersion and Confirmation of Gelation State and Liquid Drainability>

First, a sample and water were weighed out so that the aqueous dispersion had a solid content of 1% by weight. This solution was then dispersed with a “T.K. HOMO MIXER (manufactured by Primix Corporation) at 8,000 rpm for 10 minutes. This 1% by weight aqueous sample dispersion solution was then mixed with water in a 4:6 ratio, and the resultant solution was further dispersed for 5 minutes. While the temperature at this state is not especially limited, a temperature suitable for dispersing the sample was selected. Further, additives (calcium, sodium etc.) essential for the expression of functions may be added in accordance with the nature of the polysaccharide used. In the present example, calcium chloride was added when using pectin. Next, this aqueous sample dispersion was filled into three beakers. After leaving the aqueous sample dispersion filled into one of the beakers for 24 hours in a 25° C. atmosphere, if the aqueous sample dispersion flowed and spilled out when the beaker was tilted, it was determined that fluid properties were maintained and that a gel had not formed. This operation was not carried out for samples whose gelation state did not need to be confirmed.

The 0.4% by weight aqueous sample dispersion filled into another of the beakers was left to stand for 3 hours in a 25° C. atmosphere. In this standing state, a rotational viscometer (B type viscometer, manufactured by Toki Sangyo Co. Ltd., “TV-10”) was set up, and the viscosity was read out after 60 seconds. The rotor rotation speed was set at 3 rpm, and the rotor and adapter were appropriately altered in accordance with the viscosity. A stabilizer, thickening and thickening/gelling agent were selected having an arbitrary ratio of highly dispersible cellulose complex to polysaccharide, and the viscosity Z1 thereof was measured as a 0.4% by weight aqueous dispersion in the same manner.

This 1% by weight aqueous sample dispersion solution was then mixed with water in an arbitrary ratio so that the below-described “viscosity of the aqueous thickening stabilizer dispersion at a rotation speed of 3 rpm” was 2,500 to 3,000 mPa·s. The resultant solution was further dispersed for 5 minutes to thereby prepare an aqueous sample dispersion.

<Confirmation of Thickening Synergistic Effects>

The term “thickening synergistic effects” in the present invention refers to the synergistic effects specifically manifested as a result of comprising a highly dispersible cellulose complex and at least one kind of polysaccharide, or at least one kind of polysaccharide and xanthan gum.

Here, the case of the thickening agent according to the present invention will now be described in detail.

When the viscosity (viscosity Z) of the following aqueous thickening agent dispersion (or liquid-state composition) in which the thickening agent is used is greater than the theoretical viscosity α, or in other words, where the relationship “viscosity Z>theoretical viscosity α” is satisfied, a thickening synergistic effect is considered as being present.

Viscosity X: Viscosity of the aqueous dispersion when the same amount of polysaccharide contained in the thickening agent used in the preparation of viscosity Z was added as the thickening agent of viscosity Z.

Viscosity Y: Viscosity of the aqueous dispersion when the same amount of highly dispersible cellulose complex contained in the thickening agent used in the preparation of viscosity Z was added as the thickening agent of viscosity Z.

Viscosity Z: Viscosity of the aqueous dispersion of the thickening agent listed in item 3 of paragraph 0011.

α: Viscosity theoretical value estimated from viscosity X and viscosity Y from the following formula.
Viscosity α=[β×viscosity X+γ×viscosity Y]/(β+γ)
β: Amount of polysaccharide (% by weight) contained in the aqueous thickening agent dispersion used when determining viscosity Z.
γ: Amount of highly dispersible cellulose complex (% by weight) contained in the aqueous thickening agent dispersion used when determining viscosity Z.
β+γ: Amount of thickening agent (% by weight) contained in the aqueous thickening agent dispersion used when determining viscosity Z.

Here, the case of the thickening/gelling agent according to the present invention will now be described in detail.

When the viscosity ηa of the following aqueous thickening/gelling agent dispersion (or liquid-state composition) in which the thickening/gelling agent is used is greater than all of the “theoretical viscosity α′”, viscosity ηb and viscosity ηc, a thickening synergistic effect is considered as being present. Namely, such a case is when the relationship “viscosity ηa>(theoretical viscosity α′ and viscosity ηb and viscosity ηc) is satisfied; or in other words, “viscosity ηa>theoretical viscosity α′”, and “viscosity ηa>viscosity ηb”, and “viscosity ηa>viscosity ηc”.

Here, the above terms will be defined as follows. Viscosity ηa is the viscosity in the case of three components, viscosity ηb and viscosity ηc are the viscosities in the case of two components, and viscosities X′ to Z′ are the viscosity in the case of one component.

Viscosity ηα: Viscosity of an aqueous dispersion of the thickening/gelling agent.

Viscosity ηb: Viscosity of an aqueous dispersion when the same amount of a two-component composition consisting of only the highly dispersible cellulose complex and polysaccharide contained in the thickening/gelling agent used in the preparation of viscosity ηα was added as the thickening/gelling agent of viscosity ηα.

Viscosity ηc: Viscosity of an aqueous dispersion when the same amount of a two-component composition consisting of only the highly dispersible cellulose complex and xanthan gum contained in the thickening/gelling agent used in the preparation of viscosity ηα was added as the thickening/gelling agent of viscosity ηα.

Viscosity X′: Viscosity of the aqueous dispersion when the same amount of just polysaccharide contained in the thickening/gelling agent used in the preparation of viscosity ηα was added as the thickening agent of viscosity ηα.

Viscosity Y′: Viscosity of the aqueous dispersion when the same amount of just highly dispersible cellulose complex contained in the thickening/gelling agent used in the preparation of viscosity ηα was added as the thickening agent of viscosity ηα.

Viscosity Z′: Viscosity of the aqueous dispersion when the same amount of just xanthan gum contained in the thickening/gelling agent used in the preparation of viscosity ηα was added as the thickening agent of viscosity ηα.

Theoretical viscosity α′: Viscosity theoretical value estimated from viscosity X′, viscosity Y′ and viscosity Z′ from the following formula.
Theoretical viscosity α′=[β′×viscosity X′+γ′×viscosity Y′+δ′×viscosity Z′]/(β′+γ′+δ′)
β′: Amount of polysaccharide (% by weight) contained in the aqueous thickening/gelling agent dispersion used when determining viscosity ηα.
γ′: Amount of highly dispersible cellulose complex (% by weight) contained in the aqueous thickening/gelling agent dispersion used when determining viscosity ηα.
δ′: Amount of xanthan gum (% by weight) contained in the aqueous thickening/gelling agent dispersion used when determining viscosity ηα.
β′+γ′+δ′: Amount of thickening/gelling agent (% by weight) contained in the aqueous thickening/gelling agent dispersion used when determining viscosity ηα.
<Calculation of Structural Viscosity Index (TI value) and Determination of Formation Effect>

The structural viscosity formation effect according to the present invention is represented as the structural viscosity index (TI value) as calculated from: “viscosity at a rotation speed of 3 rpm (η3)” and “viscosity at a rotation speed of 100 rpm (η100)”. Stability tends to depend on η3, and thus structural viscosity indices (TI values) are compared between aqueous dispersions (or liquid-state compositions) which have been adjusted so that their η3 express about the same viscosity. The term “TI value” used here is represented by “TI=η3/η100”, wherein the higher the TI value, the better liquid drainability is and the lower the sense of pasty feeling or sliminess is.

The structural viscosity index (TI=η3/η100) of an aqueous sample dispersion aqueous composition dispersion, prepared by mixing the above-obtained 1% by weight aqueous sample dispersion solution with water in an arbitrary ratio so that the “viscosity of the aqueous thickening stabilizer dispersion at a rotation speed of 3 rpm” was 2,500 to 3,000 mPa·s, and then dispersing the resultant solution for a further 5 minutes, was calculated from the “viscosity at a rotation speed of 3 rpm (η3)” and “viscosity at a rotation speed of 100 rpm (η100)”.

The structural viscosity index (TIα) of the aqueous composition dispersion of the present invention is determined from “TIα=η3α/η100 α”.

η3α: Viscosity of an aqueous dispersion of the composition according to the present invention at 3 rpm.

η100α: Viscosity of an aqueous dispersion of the composition according to the present invention at 100 rpm.

The structural viscosity index (TIβ) of the aqueous dispersion of the polysaccharide contained in the composition according to the present invention used in the adjustment of the viscosities η3α and η100α can be determined from “TIβ=η3β/η100 β”.

η3β: Viscosity at 3 rpm of an aqueous dispersion of the polysaccharide contained in the composition according to the present invention used in the adjustment of the viscosity η3α.

(however, the added amount of polysaccharide is adjusted so that η3β≈η3α; i.e. “0.9≦η3α/η3β≦1.1”.)

η100β: Viscosity at 100 rpm of an aqueous dispersion of the polysaccharide contained in the composition according to the present invention used in the adjustment of the viscosity η100α.

When the above-determined structural viscosity indices TIα and TIβ satisfy the relationship “TIα>TIβ”, the aqueous composition dispersion is considered to have a structural viscosity formation effect.

<Confirmation of Gelation State and Liquid Drainability, and Viscosity Measurement of Food Items (Fruit Sauce, Fermented Milk Drink and Corn Soup)>

Liquid-state compositions prepared in accordance with the below-described examples were each filled into three beakers. After leaving one of the food items filled into a beaker for 24 hours, if the aqueous sample dispersion flowed and spilled out when the beaker was tilted, it was determined that fluid properties were maintained and that a gel had not formed. This operation was not carried out for samples whose gelation state did not need to be confirmed. When the beaker was tilted and then returned to its original position, if the liquid-state composition tightly adhered to the lip of the beaker, or formed some threads, liquid drainability was determined to be poor, and if the liquid-state composition drained out without adhering, liquid drainability was determined to be good.

Two food items filled into the beakers were left to stand for 3 hours in a 25° C. atmosphere. In this standing state, a rotational viscometer (B type viscometer, manufactured by Toki Sangyo Co. Ltd., “TV-10”) was set up, and the viscosity was read out after 60 seconds. The viscosity of the liquid-state composition filled into one of the beakers was measured at a rotor rotation speed of 3 rpm, and the viscosity of the liquid-state composition filled into the other beaker was measured at a rotor rotation speed of 100 rpm. The rotor and adapter were appropriately altered in accordance with the viscosity.

<Determination of Sense of Pasty Feeling of Food Items (Fruit Sauce, Fermented Milk Drink and Corn Soup)>

A sensory test was conducted by making twenty people eat 1 g of the remaining food items used in the above-described measurement of “viscosity (η3) at a rotation speed of 3 rpm”, to thereby determine “percentage (%) of those who felt a sense of pasty feeling=number of people who felt a sense of pasty feeling/20×100”. The sensory tests of the following examples were all carried out using the same twenty people.

<pH>

pH was measured a pH meter (“HM-50G”, manufactured by DKK-Toa Corporation)

The pH of the gelatinous composition was measured by adjusting a blank solution of the gelatinous composition without adding a thickening/gelling agent or a calcium salt.

<Grain Number Measurement for Fruit Sauce, Fermented Milk Drink and Corn Soup>

In accordance with the following method, these liquid-state compositions were prepared and sprinkled with 20 grains per filled vessel. After a predetermined length of time had elapsed, the number of grains floating on the liquid surface or the number that had sedimented to the bottom were visually counted. The numbers were plugged into the following grain immobilization index (%) formula to determine the grain immobilization index (%). In cases where the added grains are small, 50 grains instead of 20 grains may be added.

<Grain Number Measurement for Grilled Beef Sauce>

In accordance with the following method, liquid-state compositions were prepared and sprinkled with 40 grains per filled vessel. After a predetermined length of time had elapsed, the number of grains floating on the liquid surface and the number that had sedimented to the bottom were visually counted. The numbers were plugged into the following grain immobilization index (%) formula to determine the grain immobilization index (%).

<Grain Immobilization Index and Grain Immobilization Effects>

The grain immobilization index (%) is calculated using the following formula.
Grain immobilization index (%)=[{δ−(ε+θ)}/δ]×100

δ: Total number of grains

ε: Number of grains floating on the liquid surface

θ: Number of grains sedimented on the bottom

When the grain immobilization index of the aqueous dispersion which used the stabilizer or the thickening/gelling agent according to the present invention is greater than the grain immobilization index of the aqueous dispersion prepared to the same concentration but which used only a polysaccharide or a polysaccharide and a xanthan gum, a grain immobilization effect is considered as being present. Specifically, a grain immobilization effect is considered as being present when the following grain immobilization indices S and U satisfy the relationship “grain immobilization index S>grain immobilization index U”.

Grain immobilization index S: Grain immobilization index when the stabilizer according to the present invention is used for the aqueous dispersion.

Grain immobilization index U: Grain immobilization index when the polysaccharide contained in the stabilizer used when determining the grain immobilization index X is used for the aqueous dispersion.

One of the following was used as the model grains.

(1) Spherical grains a: Grains made from polypropylene (major axis of 2.4 mm, minor axis of 2.4 mm, average grain size of 2.4 mm, and specific gravity of 0.9).

(2) Spherical grains b: Grains made from polyacetal resin (major axis of 2.4 mm, minor axis of 2.4 mm, average grain size of 2.4 mm, and specific gravity of 1.4).

(3) Plate-like grains c: Grains made from paper (rectangular, major axis of 5 mm, minor axis of 3 mm, thickness of 0.3 mm, and specific gravity of 0.9).

(4) Plate-like grains d: Grains made from polyethylene terephthalate (rectangular, major axis of 5 mm, minor axis of 3 mm, thickness of 0.3 mm, and specific gravity of 1.4).

<Grain Dimension Measurement>

Grain dimension measurement was conducted by observing a grain with a microscope, or by measuring with a micrometer, to determine the major axis and the minor axis. The number of repetitions in this step was 30.

<Average Grain Size of the Spherical Grains>

The average grain size was calculated according to “(major axis+minor axis)/2” from the major axis and minor axis. The number of repetitions in this step was 30.

<Grain Specific Gravity>

Specific gravity was calculated according to JIS Z 8807-1976 (Measuring methods for specific gravity solid).

<Heat Resistance of Gel>

Although the gel obtained from the thickening/gelling agent of the present invention has heat resistance, the term “heat resistance” as used here refers to the function of maintaining the position in the gel of contents (also referred to as “grains”) which are immobilized uniformly in a dispersed state in the gel, in their original state even without changing when subjected to a high temperature heat treatment such as the conditions found in retort sterilization. Heat resistance can be determined according to any of the following methods (1) to (4) or (1′) to (4′) depending on the type thickening/gelling agent which is used.

(1) A 1% by weight aqueous dispersion of the thickening/gelling agent is prepared, and using the above-described “plate-like grains c” as the grains, 20 grains per vessel are added.

(2) A heat treatment is conducted for 1 hour at 90° C.

(3) After the heat treatment is finished, the state of the heat resistant gel at 80° C. is visually checked, and the number of grains floating on the liquid surface and the number that had sedimented to the bottom are counted.

(4) Determination of heat resistance: Based on the respective number of grains counted in item (3), the value is calculated using the above-described grain immobilization index formula. When this immobilization index is 70% or more, heat resistance is determined as being present.

(1′) An aqueous dispersion by adjusting the concentration of the thickening/gelling agent so that the rupture strength of the gel at 5° C. as measured in the following manner is in the range of 1.4 N to 1.5 N. Using the above-described “plate-like grains c” as the grains, this aqueous dispersion is charged with 20 grains per vessel.

(2′) A heat treatment is conducted for 30 minutes at 120° C.

(3′) After the heat treatment is finished, the solution is cooled for 3 hours at 25° C. while maintaining in a standing state. The number of grains floating on the liquid surface and the number that had sedimented to the bottom are counted.

(4′) Determination of heat resistance: Based on the respective number of grains counted in item (3′), the value is calculated using the above-described grain immobilization index formula. When this immobilization index is 60% or more, heat resistance is determined as being present.

<Measurement of Rupture Strength, Rupture Stress Factor and Brittleness Stress Factor>

(1) Heat resistant wrap is stuck onto one side of the lip portion of cylindrical vessels made from stainless steel having an inner diameter of about 45 mm and a height of 5 cm. The wrap is held with a rubber band to prepare the vessels to be used for filling the gel.

(2) An aqueous gelling agent dispersion was prepared (but no grains were added therein) in the same manner as items (1) to (2) or (1′) to (2′) of the gel heat resistance evaluation. The prepared dispersion was then filled into the vessels to a height of about 40 mm.

(3) Heat resistant wrap is wrapped around the vessels and held with a rubber band to seal the vessels.

(4) The vessels containing the gel are heated in an 80° C. water bath for 1 hour, and then cooled at 5° C. for 24 hours.

(5) The wrap at the upper portion and lower portion of the vessels is removed, and each vessel is placed upside down on the test stand of a rheometer so that the bottom of the gel faces upwards.

(6) The vessels are carefully removed, and in a state such that only the gel is mounted on the test stand, the thickness (mm) of a standard gel sample is measured for measurement of the rupture strength using a rheometer.

(7) From the obtained rupture pattern, the “rupture strength (N)” which serves as the load value at the rupture point is read out, and it is confirmed that the value is between 1.4 to 1.5 N. Subsequently, the “rupture deformation (mm)” and “brittleness deformation (mm)” are also read out. Here, “rupture deformation (mm)” represents the deformation distance at the rupture point, and “brittleness deformation (mm)” represents the deformation distance until the point of brittleness from the rupture point. FIG. 1 illustrates the way of reading the rupture pattern.

(8) The rupture strain factor is calculated according to the following formula from the thickness of the standard gel sample measured in item (6) and the rupture deformation (mm) obtained in item (7).
Rupture strain factor=rupture deformation (mm)/sample thickness (mm)×100
(9) Brittleness strain factor is the ratio of the brittleness deformation to the thickness of the original sample, and is calculated according to the following formula from the thickness of the standard gel sample measured in item (6) and the brittleness deformation (mm) obtained in item (7).
Brittleness strain factor (%)=brittleness deformation (mm)/sample thickness (mm)×100

### EXAMPLES

The present invention will now be described in more detail by illustrating with the following examples and comparative examples. However, the present invention is not intended to be limited to these examples and comparative examples. The water-dispersible cellulose, highly dispersible cellulose complex, guar gum, pectin, glucomannan, xantham gum, locust bean gum, deacetylated gellan gum, gelatin and agar used in the examples and comparative examples are illustrated in the following (1) to (10).

(1) Adjustment of Highly Dispersible Cellulose Complex A

Commercially available wheat straw pulp (average degree of polymerization of 930, α-cellulose content of 68% by weight) was cut into rectangles having sides of 6×12 mm. Water was added thereto so as to give a concentration of 4% by weight. The mixture was stirred with a domestic mixer for 5 minutes. The mixture was then dispersed with a high-speed rotational homogenizer (Ultra-Disperser, manufactured by Yamato Kagaku) for one hour.

The resultant aqueous dispersion was treated with a whetstone-rotation type grinder (grinder rotation speed: 1,800 rpm). This treatment was carried out twice, wherein the grinder clearance was first 60 μm, which was then changed to 40 μm.

The resultant aqueous dispersion was then diluted with water so that the concentration was 2% by weight. This solution was subjected to eight passes with a high-pressure homogenizer (treatment pressure of 175 MPa), to thereby obtain a water-dispersible cellulose A slurry. This slurry had a crystallinity of 74%. When observed with an optical microscope, a fine-fibrous cellulose was observed having a major axis of 10 to 700 μm, a minor axis of 1 to 30 μm, and a major axis/minor axis ratio of 10 to 150. The loss tangent was 0.43. The content of the “component stably suspensible in water” was 89% by weight. When this component was observed using a high-resolution SEM, an extremely fine-fibrous cellulose was observed having a major axis of 1 to 20 μm, a minor axis of 6 to 300 nm, and a major axis/minor axis ratio of 30 to 350. Dispersibility in 0.01% aqueous potassium chloride was 85%.

The water-dispersible cellulose A slurry was charged with sodium carboxymethyl cellulose (1% by weight aqueous solution, viscosity of about 3,400 mPa·s) and dextrin (DE of about 28) so that the concentration of water-dispersible cellulose A slurry:carboxymethyl-cellulose:dextrin:soybean oil was 63:15:21.5:0.5 (parts by weight). 15 kg of this solution was then mixed by stirring with a stirring homogenizer (“T.K. AUTO HOMO MIXER”, manufactured by Primix Corporation) at 8,000 rpm for 10 minutes. The resultant solution was then subjected to a one-pass treatment with the above-described high-pressure homogenizer at 20 MPa, to thereby obtain a water-dispersible cellulose A′ slurry.

The water-dispersible cellulose A′ slurry was then dried using a drum drier and scraped out with a scraper. The resultant product was pulverized by a cutter mill (manufactured by Fuji Poudal, Co., Ltd.) to such an extent that the pulverized material could almost completely pass through a sieve having a mesh size of 2 mm, and was then further pulverized by an impact pulverizer so that the pulverized material could pass through a standard sieve having a mesh size of 425 μm, to thereby obtain a highly dispersible cellulose complex C. The highly dispersible cellulose complex A had a crystallinity of 58% or more, and a loss tangent of 0.68. The content of the “component stably suspensible in water” was 89% by weight. When the “component stably suspensible in water” was observed using a high-resolution SEM, an extremely fine-fibrous cellulose was observed having a major axis of 1 to 12 μm, a minor axis of 6 to 250 nm, and a major axis/minor axis ratio of 20 to 200.

(2) Adjustment of Highly Dispersible Cellulose Complex B

Commercially available bagasse straw pulp (average degree of polymerization of 1,320 α-cellulose content of 77% by weight) was cut into rectangles having sides of 6×16 mm. Water was added thereto so as to give a solid content of 77% by weight. Taking care that the water and bagasse pulp did not separate, the solution was passed once through a cutter mill (gap between the cutting head and horizontal blade of 2.03 mm, impeller rotation speed of 3,600 rpm). The cutter mill treated product, sodium carboxymethyl cellulose (1% by weight aqueous solution, viscosity of about 3,400 mPa·s) and water were weighed out so that the concentration of cellulose came to 2% by weight and the concentration of sodium carboxymethyl cellulose came to 0.118% by weight, and the resultant mixture was stirred until there was no entanglement between fibers. The obtained aqueous dispersion was subjected as is to nine passes with a high-pressure homogenizer (treatment pressure of 90 MPa), to thereby obtain a water-dispersible cellulose B slurry. When observed with an optical microscope and a medium-resolution SEM, a fine-fibrous cellulose was observed having a major axis of 10 to 500 μm, a minor axis of 1 to 25 μm, and a major axis/minor axis ratio of 5 to 190. The loss tangent was 0.32. The content of the “component stably suspensible in water” was 99% by weight. When the “component stably suspensible in water” was observed using a high-resolution SEM, an extremely fine-fibrous cellulose was observed having a major axis of 1 to 20 μm, a minor axis of 10 to 400 nm, and a major axis/minor axis ratio of 20 to 300.

The water-dispersible cellulose B slurry was charged with sodium carboxymethyl cellulose (1% by weight aqueous solution, viscosity of about 3,400 mPa·s) and dextrin (DE of about 28) so that the concentration of water-dispersible cellulose B slurry:carboxymethyl-cellulose:dextrin:soybean oil was 63:15:21.5:0.5 (parts by weight). 15 kg of this solution was then mixed by stirring with a stirring homogenizer (“T.K. AUTO HOMO MIXER”, manufactured by Primix Corporation) at 8,000 rpm for 10 minutes. The resultant solution was then subjected to a one-pass treatment with the above-described high-pressure homogenizer at 20 MPa, to thereby obtain a water-dispersible cellulose B′ slurry.

The water-dispersible cellulose B′ slurry was then dried using a drum drier and scraped out with a scraper. The resultant product was pulverized by a cutter mill (manufactured by Fuji Poudal, Co., Ltd.) to such an extent that the pulverized material could almost completely pass through a sieve having a mesh size of 2 mm, and was then further pulverized by an impact pulverizer so that the pulverized material could pass through a standard sieve having a mesh size of 425 μm, to thereby obtain a highly dispersible cellulose complex C. The highly dispersible cellulose complex B had a crystallinity of 58% or more, and a loss tangent of 0.58. The content of the “component stably suspensible in water” was 99% by weight. When the “component stably suspensible in water” was observed using a high-resolution SEM, an extremely fine-fibrous cellulose was observed having a major axis of 1 to 12 μm, a minor axis of 10 to 330 nm, and a major axis/minor axis ratio of 20 to 220. Dispersibility in 0.01% aqueous potassium chloride was 66%.

(3) Guar gum (manufactured by Unitec Foods Co., Ltd.)

(4) Pectin (LM pectin, manufactured by CP Kelco)

(5) Glucomannan (manufactured by Shimizu Chemical Corporation)

(6) Xantham gum (manufactured by Dainippon Sumitomo Phrma Co., Ltd.)

(7) Locust bean gum (manufactured by Unitec Foods Co., Ltd.)

(8) Deacetylated gellan gum (manufactured by San-Ei Gen F. F. I., Inc.)

(9) Gelatin (manufactured by Jellice Co., Ltd.)

(10) Agar (in general) (manufactured by Ina Food Industry Co., Ltd.)

### Example 1

A composition containing the highly dispersible cellulose complex A and guar gum in a 6:4 ratio was selected. First, the above-described sample and water were weighed out so that the aqueous solution had a solid content of 1% by weight. This solution was dispersed using the “T.K. AUTO HOMO MIXER” (manufactured by Primix Corporation) at 25° C. and 8,000 rpm for 10 minutes. This 1% by weight aqueous sample dispersion and water were mixed in a ratio of 4:6, and the resultant solution was dispersed for another 5 minutes to prepare a 0.4% by weight aqueous sample dispersion. The thus-prepared dispersion was filled into three beakers. The 0.4% by weight aqueous sample dispersion filled into one of the beakers was left to stand for 24 hours in a 25° C. atmosphere. When tilted, the aqueous sample dispersion flowed and spilled out. This aqueous sample dispersion had not turned into a gel, and had good liquid drainability. The 0.4% by weight aqueous sample dispersions filled into the remaining two beakers were left to stand for 3 hours in a 25° C. atmosphere. In this standing state, a rotational viscometer (B type viscometer, manufactured by Toki Sangyo Co. Ltd., “TV-10”) was set up, and the viscosity was read out after 60 seconds. At this point, the rotor and adapter were appropriately altered in accordance with the viscosity. The viscosity (η3α1) of the 0.4% by weight aqueous sample dispersion filled into one of the beakers was measured at a rotor rotation speed of 3 rpm to be 2,600 mPa·s. The viscosity (η100α1) of the 0.4% by weight aqueous sample dispersion filled into the other beaker was measured at a rotor rotation speed of 100 rpm to be 201 mPa·s. The structural viscosity index (TIα1) of the 0.4% by weight aqueous sample dispersion at this point was: TIα1=(η3α1)/(η100α1)=13.

Measurement of the theoretical viscosity a from the viscosity X1 of the 0.4% by weight aqueous guar gum dispersion (312 mPa·s) and the viscosity Y1 of the 0.4% by weight aqueous highly dispersible cellulose complex A dispersion (1,780 mPa·s) as measured by the above-described method gave a theoretical viscosity α1 of 1,193 mPa·s. The relationship between the viscosity Z1 of the 0.4% by weight aqueous composition dispersion (2,600 mPa·s) and the theoretical viscosity α1 (1,193 mPa·s) was “viscosity Z1>theoretical viscosity α1”, whereby it was determined that this thickening agent had a thickening synergistic effect.

In the same manner, the viscosity (η3γ1) of a 0.62% by weight aqueous guar gum dispersion at a rotor rotation speed of 3 rpm was measured to be 2,550 mPa·s, and η3α1/η3γ1 was 1.0. In addition, the viscosity (η100γ1) of a 0.62% by weight aqueous guar gum dispersion at a rotor rotation speed of 100 rpm was measured to be 593 mPa·s. The structural viscosity index (TIγ1) of the 0.62% by weight aqueous guar gum solution at this point was: TIβ1=(η3γ1)/(η100γ1)=4.

Accordingly, the relationship between the structural viscosity index (TIα1) and the structural viscosity index (TIβ1) was “structural viscosity index (TIα1)>structural viscosity index (TIβ1)”, whereby it was determined that this thickening stabilizer had an effect on structural viscosity formation.

The above-described 1% by weight aqueous sample dispersion and water were mixed in a ratio of 3.5:6.5, and the resultant solution was dispersed for another 5 minutes to prepare a 0.35% by weight aqueous stabilizer solution, which was then filled into four 100 mL sample bottles. One of the bottles filled with the 0.35% by weight aqueous sample dispersion was charged with 20 grains of spherical grains a”. The resultant mixture was temperature-adjusted for 1 hour at 25° C., after which the mixture was mixed by vigorously shaking the sample bottle up and down. The mixture was left to stand for 3 hours at 25° C., and then the number of grains floating on the liquid surface or that had sedimented to the bottom were visually counted to determine the grain immobilization index (%). The grain immobilization index when the spherical grains a” were added is referred to as “S(a1)”. Similarly, instead of spherical grains a, the grain immobilization index when “spherical grains b” were added is referred to as “S(b1)”. Similarly, instead of spherical grains a, the grain immobilization index when “plate-like grains c” were added is referred to as “S(c1)”. Similarly, instead of spherical grains a, the grain immobilization index when “plate-like grains d” were added is referred to as “S(d1)”. These results are shown in Table 1.

[Table 1]

TABLE 1

| Grain | Grain immobilization index S (%) | | |
|---|---|---|---|
| immobilization | | | |
| index | | | |
| Described | Example 1 | | |
| location | | | |
| Stabilizer | Stabilizer containing highly | | Grain |
| | dispersible cellulose complex A | | immobilization |
| | and guar gum in a weight ratio of | | effect in |
| | 6:4 | | Example 1 |
| Results | S(a1) | 85 | Yes |
| | S(b1) | 75 | Yes |
| | S(c1) | 90 | Yes |
| | S(d1) | 85 | Yes |

### Example 2

A composition containing the highly dispersible cellulose complex B and guar gum in a weight ratio of 8:2 was selected. 1.0% by weight and 0.4% by weight aqueous composition dispersions were prepared in the same manner as in Example 1, and evaluated. The 0.4% by weight aqueous thickening agent dispersion maintained its fluid properties and had not turned into a gel. Measurement of the theoretical viscosity from the viscosity X2 of the 0.4% by weight aqueous guar gum dispersion (312 mPa·s) and the viscosity Y2 of the 0.4% by weight aqueous highly dispersible cellulose complex B dispersion (2,010 mPa·s) gave a theoretical viscosity α2 of 1,670 mPa·s. In addition, the relationship between the viscosity Z2 of the 0.4% by weight aqueous thickening agent dispersion (2,700 mPa·s) and the theoretical viscosity α3 (1,670 mPa·s) was “viscosity Z2>theoretical viscosity α2”, whereby it was determined that this aqueous composition dispersion had a thickening synergistic effect.

The viscosity (η3α2) of the 0.4% by weight aqueous composition dispersion at a rotation speed of 3 rpm was measured to be 2,690 mPa·s, and the viscosity (η100α2) at a rotation speed of 100 rpm was measured to be 259 mPa·s. The structural viscosity index (TIα2) of the 0.4% by weight aqueous composition dispersion at this point was: TIα2=(η3α2)/(η100α2)=10.

The structural viscosity index (TIβ2) of a 0.62% by weight aqueous guar gum solution obtained in the same manner as Example 1 was: TIβ2=(η3β2)/(η100β2)=4. Accordingly, the structural viscosity index (TIα2) was greater than the structural viscosity index (TIβ2), whereby it was determined that this aqueous composition dispersion had an effect on structural viscosity formation.

A 0.35% by weight aqueous composition solution was prepared in the same manner as in Example 1 by mixing the above-described 1.0% by weight aqueous sample dispersion and water in a ratio of 3.5:6.5, and then dispersing the resultant solution for another 5 minutes. The grain immobilization index when 20 grains of “spherical grains a” were added to this solution is referred to as “S(a2)”. Similarly, instead of spherical grains a, the grain immobilization index when “spherical grains b” were added is referred to as “S(b2)”. Similarly, instead of spherical grains a, the grain immobilization index when “plate-like grains c” were added is referred to as “S(c2)”. Similarly, instead of spherical grains a, the grain immobilization index when “plate-like grains d” were added is referred to as “S(d2)”. These results are shown in Table 2.

[Table 2]

TABLE 2

| Grain | Grain immobilization index S (%) | | |
|---|---|---|---|
| immobilization | | | |
| index | | | |
| Described | Example 2 | | |
| location | | | |
| Stabilizer | Stabilizer containing highly | | Grain |
| | dispersible cellulose complex B | | immobilization |
| | and guar gum in a weight ratio of | | effect in |
| | 8:2 | | Example 2 |
| Results | S(a2) | 90 | Yes |
| | S(b2) | 80 | Yes |
| | S(c2) | 95 | Yes |
| | S(d2) | 85 | Yes |

### Example 3

A composition containing the highly dispersible cellulose complex B and guar gum in a weight ratio of 6:4 was selected. A 0.4% by weight aqueous composition dispersion was prepared in the same manner as in Example 1, and evaluated. This 0.4% by weight aqueous composition dispersion maintained its fluid properties and had not turned into a gel.

Measurement of the theoretical viscosity from the viscosity X3 of the 0.4% by weight aqueous guar gum dispersion (312 mPa·s) and the viscosity Y3 of the 0.4% by weight aqueous highly dispersible cellulose complex B dispersion (2,010 mPa·s) gave a theoretical viscosity a3 of 1,331 mPa·s. In addition, the relationship between the viscosity Z3 of the 0.4% by weight aqueous thickening agent dispersion (3,350 mPa·s) and the theoretical viscosity α4 (1,331 mPa·s) was “viscosity Z3>theoretical viscosity α3”, whereby it was determined that this aqueous composition dispersion had a thickening synergistic effect.

When a 0.33% by weight aqueous thickening stabilizer dispersion was prepared in the same manner as in Example 1, the dispersion maintained its fluid properties, had not turned into a gel, and had good liquid drainability. Further, the viscosity (η3α3) at a rotation speed of 3 rpm was 2,710 mPa·s, and the viscosity (η100α3) at a rotation speed of 100 rpm was 204 mPa·s. The structural viscosity index (TIα3) of this 0.33% by weight aqueous thickening stabilizer dispersion was: TIα3=(η3α3)/(η100α3)=13. The structural viscosity index (TIβ3) of a 0.62% by weight aqueous guar gum solution obtained in the same manner as Example 1 was: TIβ3=(η3β3)/(η100β3)=4. Accordingly, the structural viscosity index (TIα3) was greater than the structural viscosity index (TIβ3), whereby it was determined that this aqueous composition dispersion had an effect on structural viscosity formation.

A 0.35% by weight aqueous composition solution was prepared in the same manner as in Example 1 by mixing the above-described 1.0% by weight aqueous composition dispersion and water in a ratio of 3.5:6.5, and then dispersing the resultant solution for another 5 minutes. The grain immobilization index when 20 grains of “spherical grains a” were added to this solution is referred to as “S(a3)”. Similarly, instead of spherical grains a, the grain immobilization index when “spherical grains b” were added is referred to as “S(b3)”. Similarly, instead of spherical grains a, the grain immobilization index when “plate-like grains c” were added is referred to as “S(c3)”. Similarly, instead of spherical grains a, the grain immobilization index when “plate-like grains d” were added is referred to as “S(d3)”. These results are shown in Table 3.

[Table 3]

TABLE 3

| Grain | Grain immobilization index S (%) | | |
|---|---|---|---|
| immobilization | | | |
| index | | | |
| Described | Example 3 | | |
| location | | | |
| Stabilizer | Stabilizer containing highly | | Grain |
| | dispersible cellulose complex B | | immobilization |
| | and guar gum in a weight ratio of | | effect in |
| | 6:4 | | Example 3 |
| Results | S(a3) | 100 | Yes |
| | S(b3) | 90 | Yes |
| | S(c3) | 100 | Yes |
| | S(d3) | 95 | Yes |

### Example 4

A composition containing the highly dispersible cellulose complex B and guar gum in a weight ratio of 4:6 was selected. A 0.4% by weight aqueous composition dispersion was prepared in the same manner as in Example 1, and evaluated. This 0.4% by weight aqueous composition dispersion maintained its fluid properties and had not turned into a gel.

Measurement of the theoretical viscosity from the viscosity X4 of the 0.4% by weight aqueous guar gum dispersion (312 mPa·s) and the viscosity Y4 of the 0.4% by weight aqueous highly dispersible cellulose complex B dispersion (2,010 mPa·s) gave a theoretical viscosity α4 of 991 mPa·s. In addition, the relationship between the viscosity Z4 of the 0.4% by weight aqueous composition dispersion (2,480 mPa·s) and the theoretical viscosity α4 (991 mPa·s) was “viscosity Z4>theoretical viscosity α4”, whereby it was determined that this aqueous composition dispersion had a thickening synergistic effect.

When a 0.50% by weight aqueous thickening stabilizer dispersion was prepared in the same manner as in Example 1, the dispersion maintained its fluid properties, had not turned into a gel, and had good liquid drainability. Further, the viscosity (η3α4) at a rotation speed of 3 rpm was 2,580 mPa·s, and the viscosity (η100α4) at a rotation speed of 100 rpm was 232 mPa·s. The structural viscosity index (TIα4) of this 0.5% by weight aqueous thickening stabilizer dispersion was: TIα4=(η3α4)/(η100α4)=11. The structural viscosity index (TIβ4) of a 0.62% by weight aqueous guar gum solution obtained in the same manner as Example 1 was: TIβ4=(η3β4)/(η100β4)=4. Accordingly, the structural viscosity index (TIα4) was greater than the structural viscosity index (TIβ4), whereby it was determined that this aqueous composition dispersion had an effect on structural viscosity formation.

A 0.35% by weight aqueous composition solution was prepared in the same manner as in Example 1 by mixing the above-described 1.0% by weight aqueous composition dispersion and water in a ratio of 3.5:6.5, and then dispersing the resultant solution for another 5 minutes. The grain immobilization index when 20 grains of “spherical grains a” were added to this solution is referred to as “S(a4)”. Similarly, instead of spherical grains a, the grain immobilization index when “spherical grains b” were added is referred to as “S(b4)”. Similarly, instead of spherical grains a, the grain immobilization index when “plate-like grains c” were added is referred to as “S(c4)”. Similarly, instead of spherical grains a, the grain immobilization index when “plate-like grains d” were added is referred to as “S(d4)”. These results are shown in Table 4.

[Table 4]

TABLE 4

| Grain | Grain immobilization index S (%) | | |
|---|---|---|---|
| immobilization | | | |
| index | | | |
| Described | Example 4 | | |
| location | | | |
| Stabilizer | Stabilizer containing highly | | Grain |
| | dispersible cellulose complex B | | immobilization |
| | and guar gum in a weight ratio of | | effect in |
| | 4:6 | | Example 4 |
| Results | S(a4) | 65 | Yes |
| | S(b4) | 65 | Yes |
| | S(c4) | 75 | Yes |
| | S(d4) | 65 | Yes |

### Example 5

A composition containing the highly dispersible cellulose complex B and glucomannan in a weight ratio of 6:4 was selected. 1.0% by weight and 0.4% by weight aqueous composition dispersions were prepared in the same manner as in Example 1. These dispersions maintained their fluid properties and had not turned into a gel.

Measurement of the theoretical viscosity from the viscosity X5 of this 0.4% by weight aqueous glucomannan dispersion (372 mPa·s) and the viscosity Y5 of the 0.4% by weight aqueous highly dispersible cellulose complex B dispersion (2,010 mPa·s) gave a theoretical viscosity α5 of 1,354 mPa·s. In addition, the relationship between the viscosity Z5 of the 0.4% by weight aqueous composition dispersion (3,280 mPa·s) and the theoretical viscosity α5 (1,354 mPa·s) was “viscosity Z5>theoretical viscosity α5”, whereby it was determined that this aqueous composition dispersion had a thickening synergistic effect.

When a 0.35% by weight aqueous composition dispersion was prepared in the same manner as in Example 1, the dispersion maintained its fluid properties, had not turned into a gel, and had good liquid drainability.

Further, the viscosity (η3α5) of the 0.35% by weight aqueous composition dispersion at a rotation speed of 3 rpm was 2,890 mPa·s, and the viscosity (η100α5) at a rotation speed of 100 rpm was 243 mPa·s. The structural viscosity index (TIα5) of this 0.35% by weight aqueous thickening stabilizer dispersion was: TIα5=(η3α5)/(η100α5)=12. The structural viscosity index (TIβ5) of a 0.67% by weight aqueous glucomannan solution obtained in the same manner as Example 1 was measured to be 2,910 mPa·s, and (η3β5)/(η3β5) was 1.0. Further, the viscosity (η100β5) of this 0.67% by weight aqueous glucomannan solution at a rotation speed of 100 rpm was 1,312 mPa·s. The structural viscosity index (TIβ5) of this 0.67% by weight aqueous glucomannan solution at this stage was: TIβ5=(η3β5)/(η100β5)=2.

Accordingly, the structural viscosity index (TIα5) was greater than the structural viscosity index (TIβ5), whereby it was determined that this aqueous composition dispersion had an effect on structural viscosity formation.

A 0.35% by weight aqueous composition solution was prepared in the same manner as in Example 1 by mixing the above-described 1.0% by weight aqueous composition dispersion and water in a ratio of 3.5:6.5, and then dispersing the resultant solution for another 5 minutes. The grain immobilization index when 20 grains of “spherical grains a” were added to this solution is referred to as “S(a5)”. Similarly, instead of spherical grains a, the grain immobilization index when “spherical grains b” were added is referred to as “S(b5)”. Similarly, instead of spherical grains a, the grain immobilization index when “plate-like grains c” were added is referred to as “S(c5)”. Similarly, instead of spherical grains a, the grain immobilization index when “plate-like grains d” were added is referred to as “S(d5)”. These results are shown in Table 5.

[Table 5]

TABLE 5

| Grain | Grain immobilization index S (%) | | |
|---|---|---|---|
| immobilization | | | |
| index | | | |
| Described | Example 5 | | |
| location | | | |
| Stabilizer | Stabilizer containing highly | | Grain |
| | dispersible cellulose complex B | | immobilization |
| | and glucomannan in a weight ratio | | effect in |
| | of 6:4 | | Example 5 |
| Results | S(a5) | 70 | Yes |
| | S(b5) | 75 | Yes |
| | S(c5) | 80 | Yes |
| | S(d5) | 80 | Yes |

### Example 6

A composition containing the highly dispersible cellulose complex B and pectin in a weight ratio of 8:2 was selected. A 0.4% by weight aqueous composition dispersion was prepared in the same manner as in Example 1. This dispersion maintained its fluid properties and had not turned into a gel.

Measurement of the theoretical viscosity from the viscosity X6 of this 0.4% by weight aqueous pectin dispersion (1,010 mPa·s) and the viscosity Y6 of the 0.4% by weight aqueous highly dispersible cellulose complex B dispersion (2,010 mPa·s) gave a theoretical viscosity α6 of 1,810 mPa·s. In addition, the relationship between the viscosity Z6 of the 0.4% by weight aqueous composition dispersion (2,210 mPa·s) and the theoretical viscosity α6 (1,810 mPa·s) was “viscosity Z6>theoretical viscosity α6”, whereby it was determined that this aqueous composition dispersion had a thickening synergistic effect.

In addition, a 0.5% by weight aqueous composition dispersion was dispersed in the same manner as in Example 1 at 80° C. The resultant solution was charged with 100 mg of calcium chloride per 1 g of composition, and then dispersed for 2 minutes. The solution was left to stand in the same manner as in Example 1, and then evaluated. This 0.5% by weight aqueous composition dispersion maintained its fluid properties, had not turned into a gel, and had good liquid drainability. Further, the viscosity (η3α6) at a rotation speed of 3 rpm was 2,760 mPa·s, and the viscosity (η100α6) at a rotation speed of 100 rpm was 229 mPa·s. The structural viscosity index (TIα) of this 0.5% by weight aqueous composition-dispersion was: TIα6=(η3α6)/(η100α6)=12.

Measurement of the viscosity (η3β6) of a 0.78% by weight aqueous pectin dispersion obtained by dispersing the above-described aqueous composition dispersion in the same manner, further adding to this solution 100 mg of calcium chloride per 1 g of composition, dispersing for 2 minutes and then leaving to stand in the same manner as in Example 1, was 2,820 mPa·s, and (η3α6)/(η3β6) was 1.0. The viscosity (η100β6) of the 0.78% by weight aqueous pectin solution at a rotation speed of 100 rpm was 317 mPa·s. The structural viscosity index (TIβ6) of this 0.78% by weight aqueous pectin solution at this stage was: TIβ6=(η3β6)/(η100β6)=9.

Accordingly, the structural viscosity index (TIα6) was greater than the structural viscosity index (TIβ6), whereby it was determined that this aqueous composition dispersion had an effect on structural viscosity formation.

A 0.35% by weight aqueous composition solution was prepared in the same manner as in Example 1 by mixing the above-described 1.0% by weight aqueous composition dispersion and water in a ratio of 3.5:6.5, and then dispersing the resultant solution for another 5 minutes. The grain immobilization index when 20 grains of “spherical grains a” were added to this solution is referred to as “S(a6)”. Similarly, instead of spherical grains a, the grain immobilization index when “spherical grains b” were added is referred to as “S(b6)”. Similarly, instead of spherical grains a, the grain immobilization index when “plate-like grains c” were added is referred to as “S(c6)”. Similarly, instead of spherical grains a, the grain immobilization index when “plate-like grains d” were added is referred to as “S(d6)”. These results are shown in Table 6.

[Table 6]

TABLE 6

| Grain | Grain immobilization index S (%) | | |
|---|---|---|---|
| immobilization | | | |
| index | | | |
| Described | Example 6 | | |
| location | | | |
| Stabilizer | Stabilizer containing highly | | Grain |
| | dispersible cellulose complex A | | immobilization |
| | and pectin in a weight ratio of | | effect in |
| | 8:2 | | Example 6 |
| Results | S(a6) | 85 | Yes |
| | S(b6) | 75 | Yes |
| | S(c6) | 90 | Yes |
| | S(d6) | 80 | Yes |

### Example 7

Using a composition prepared by mixing the highly dispersible cellulose complex B and guar gum in a weight ratio of 6:4 (hereinafter, “composition a”), a fruit sauce A was prepared and evaluated according to the following procedures. A beaker was charged with 14.32% by weight of water and 40% by weight of fructose/glucose syrup (“F-55”, manufactured by Oji Cornstarch Co., Ltd.). The resultant solution was heated to 60° C., and then while stirring with a T.K. AUTO HOMO MIXER (manufactured by Primix Corporation), was mixed with a powder consisting of 0.68% by weight of the above-described composition a and 5% by weight of granulated sugar (manufactured by Daiichi-Togyo Co., Ltd.). The resultant mixture was dispersed at 8,000 rpm for 10 minutes, to thereby obtain a fruit sauce A.

The dispersion apparatus was then replaced with a propeller stirring blade, and the mixture was charged with 40% by weight of strawberry puree (prepared by thawing frozen strawberries and then pureeing) which had been sterilized by warming to 80° C. The mixture was then stirred. Once the liquid temperature reached 80° C., stirring was continued for a further 2 minutes to sterilize the mixture, to thereby produce a fruit sauce A′. The fruit sauce A′ was filled into three beakers. One of the beakers was left to stand for 24 hours at 25° C. When the beaker was tilted, the sauce flowed and spilled out. This sauce had not turned into a gel. The fruit sauce A′ filled into another one of the other beakers was left to stand for 3 hours at 25° C. Measurement showed that viscosity was 19,800 mPa·s and pH was 3.4. The viscosity (η3α7) at a rotation speed of 3 rpm measured using the fruit sauce A′ filled into the remaining two beakers, which had been left to stand for 3 hours at 25° C., was 12,700 mPa·s, and the viscosity (η100α7) at a rotation speed of 100 rpm was 1,030 mPa·s. The structural viscosity index (TIα7) of the fruit sauce A′ at this stage was: TIα7=(η3α7)/(η100α7)=12, and pH was 3.3. When 1 g of this fruit sauce A′ was given to 20 people, the percentage who felt a sense of pasty feeling was 5%, which was very low. Further, 20 blueberry grains (spherical objects having a 17 mm major axis and a 1.4 mm minor axis prepared by thawing frozen blueberries and then sterilizing by heating at 80° C.) per filled vessel were sprinkled in, to thereby produce a fruit sauce A″. This fruit sauce A″ was cooled for 1 hour at 5° C., and then mixed by vigorously shaking the vessel up and down. The blueberry grain immobilization index S(e7) after being stored for 30 days at 5° C. was 100%. These results are shown in Table 7.

[Table 7]

TABLE 7

| Grain | Grain immobilization index U (%) | | |
|---|---|---|---|
| immobilization | | | Grain |
| index | | | immobilization |
| Described | Comparative example 1 | | effect in |
| location | | | Comparative |
| Stabilizer | Guar gum | | example 1 |
| Results | U(a11) | 0 | No |
| | U(b11) | 0 | No |
| | U(c11) | 5 | No |
| | U(d11) | 0 | No |

### Example 8

Using the fruit sauce A of Example 7, a soft yoghurt B was prepared and evaluated according to the following procedures. In a clean bench, 85% by weight of the below-described yoghurt to be stirred and 15% by weight of the fruit sauce A prepared in Example 7 were mixed together. 20 blueberry grains (spherical objects having a 17 mm major axis and a 1.4 mm minor axis prepared by thawing frozen blueberries and then sterilizing by heating at 80° C.) per filled vessel were sprinkled thereon. Next, using a propeller stirring blade, the mixture was stirred for 1 minute at 400 rpm at 5° C., and the resultant product was filled into a cup, to thereby produce a soft yoghurt B. This was stored for 7 days at 5° C., whereby the blueberry grain immobilization index S(e8) was 80%. The composition a content in the soft yoghurt B at this stage was 0.1% by weight.

The soft yoghurt B was filled into two beakers. One of the beakers was left to stand for 22 hours at 5° C., and then for another 2 hours at 25° C. When the beaker was tilted, the yoghurt flowed and spilled out. This yoghurt had not turned into a gel. The soft yoghurt B filled into the other beaker was left to stand for 1 hour at 5° C., and then for another 2 hours at 25° C. Measurement showed that viscosity was 2,400 mPa·s and pH was 4.3.

The method of producing the stirring yoghurt used here was as follows.

21.7% by weight of water and 75% by weight of milk (3.5% or more milk fat content, non-fat 8.3% milk solids, manufactured by Minami Nihon Rakuno Kyodo Co., Ltd.) were poured into a stainless steel beaker. This mixture was charged with 3.3% by weight of skim milk powder (manufactured by Snow Brand Milk Products Co., Ltd.) while stirring at 200 rpm at 25° C. with a propeller stirring blade. The stirring was continued for 10 minutes.

This solution was homogenized at a treatment pressure of 15 MPa using a high-pressure homogenizer. Then, using a propeller stirring blade, stirring was carried out at 200 rpm at 80° C. for 30 more minutes to sterilize the solution. Next, in a clean bench, the solution was cooled to 30° C. over 20 minutes while stirring at 200 rpm. The solution was sprinkled with 0.32% by weight of a starter (“MSK-Mix A B N 1-45 Visbybac DIP” manufactured by Danisco Coulter) formed as a 0.01% by weight aqueous solution. The resultant mixture was collected with a spatula and filled into a fermentation vessel. The vessel was moved to an incubator, and allowed to ferment for 12 hours at 42° C. After fermentation, the vessel was moved to a refrigerator having a temperature of 5° C., and left for 3 days to thereby produce a yoghurt for stirring (9.4% or more non-fat milk solids).

### Example 9

Using the fruit sauce A of Example 7 and the stirring yoghurt of Example 8, a fermented milk drink C was prepared and evaluated according to the following procedures. In a clean bench, 30% by weight of the fruit sauce A of Example 7, 50% by weight of the stirring yoghurt of Example 8 and 20% by weight of water were mixed together for 2 minutes at 400 rpm using a propeller stirring blade. The resultant solution was homogenized at a treatment pressure of 15 MPa by a high-pressure homogenizer, and then filled into a heat-resistant vessel. The solution was subjected to a sterilization treatment for 15 minutes in an 85° C. hot water bath, to thereby produce a fermented milk drink C. The “thickening agent a” content in the fermented milk drink C at this stage was 0.2% by weight. The fermented milk drink C was filled into three beakers. One of the beakers was left to stand for 23 hours at 5° C., and then for another 1 hour at 25° C. When this beaker was tilted, the fermented milk drink C flowed and spilled out, had not turned into a gel, and had good liquid drainability. The viscosity (η3α9) at a rotation speed of 3 rpm measured using the fermented milk drink B filled into the remaining two beakers, which had been left to stand for 3 hours at 25° C., was 4,600 mPa·s, and the viscosity (η100α9) at a rotation speed of 100 rpm was 235 mPa·s. The structural viscosity index (TIα9) of the fermented milk drink C at this stage was: TIα9=(η3α9)/(η100α9)=20, and pH was 3.9. The percentage of people who felt a sense of pasty feeling when given the fermented milk drink C in the same manner as in Example 7 was 0%.

### Example 10

A corn soup D was prepared and evaluated according to the following procedures by blending with the “composition a” used in Example 9. 0.4% by weight of composition a was charged into 88.6% by weight of water while stirring with a T.K. AUTO HOMO MIXER (manufactured by Primix Corporation), and then dispersed for 5 minutes at 7,000 at 80° C. The resultant solution was then charged with 11% by weight of a commercially-available, polysaccharide-free soup (manufactured by Pokka Corporation), and the solution was then dispersed for 5 minutes. The resultant solution was filled into heat-resistant vessels, and 20 corn grains (10 mm major axis, 8 mm minor axis and 5 mm thickness) per heat-resistant vessel were sprinkled thereon. After sterilizing for 10 minutes at 85° C., and then leaving to stand for 1 hour at 25° C., the vessels were vigorously shaken up and down to thereby obtain a corn soup D. The corn soup D had a pH of 6.8 and a dietary salt concentration of 0.73% by weight. After leaving to stand for 7 days at 25° C., the corn grain immobilization index S(f10) was 95%.

These results are shown in Table 8.

[Table 8]

TABLE 8

| Grain | Grain immobilization index U (%) | | |
|---|---|---|---|
| immobilization | | | Grain |
| index | | | immobilization |
| Described | Comparative example 2 | | effect in |
| location | | | Comparative |
| Stabilizer | Glucomannan | | example 2 |
| Results | U(a12) | 0 | No |
| | U(b12) | 0 | No |
| | U(c12) | 5 | No |
| | U(d12) | 5 | No |

### Comparative Example 1

The liquid drainability of a 0.62% by weight aqueous guar gum solution prepared in the same manner as in Examples 1 and 2, except that guar gum was used in place of the compositions of Examples 1 and 2, was evaluated. When the beaker was tilted and then returned to its original position, the 0.62% by weight aqueous guar gum solution adhered to the lip of the beaker, some threads formed, and liquid drainability was poor.

In addition, a 0.35% by weight aqueous solution was prepared in the same manner as in Examples 1 and 2, except that guar gum was used in place of the compositions described in Examples 1 and 2. The grain immobilization index when 20 grains of “plate-like granules a” were added to this dispersion is referred to as “U(a11)”. Similarly, instead of spherical grains a, the grain immobilization index when “spherical grains b” were added is referred to as “U(b11)”. Similarly, instead of spherical grains a, the grain immobilization index when “plate-like grains c” were added is referred to as “U(c11)”. Similarly, instead of spherical grains a, the grain immobilization index when “plate-like grains d” were added is referred to as “U(d11)”. These results are shown in Table 9.

[Table 9]

TABLE 9

| Grain | Grain immobilization index U (%) | | |
|---|---|---|---|
| immobilization | | | Grain |
| index | | | immobilization |
| Described | Comparative example 3 | | effect in |
| location | | | Comparative |
| Stabilizer | Pectin | | example 3 |
| Results | U(a13) | 0 | No |
| | U(b13) | 0 | No |
| | U(c13) | 0 | No |
| | U(d13) | 0 | No |

### Comparative Example 2

The liquid drainability of a 0.67% by weight aqueous glucomannan solution prepared in the same manner as in Example 5, except that glucomannan was used in place of the composition of Example 5, was evaluated. When the beaker was tilted and then returned to its original position, the 0.67% by weight aqueous glucomannan solution adhered to the lip and to the outer sides of the beaker, and liquid drainability was poor.

In addition, a 0.35% by weight aqueous solution was prepared in the same manner as in Example 5, except that glucomannan was used in place of the composition described in Example 5. The grain immobilization index when 20 grains of “plate-like granules a” were added to this dispersion is referred to as “U(a12)”. Similarly, instead of spherical grains a, the grain immobilization index when “spherical grains b” were added is referred to as “U(b12)”. Similarly, instead of spherical grains a, the grain immobilization index when “plate-like grains c” were added is referred to as “U(c12)”. Similarly, instead of spherical grains a, the grain immobilization index when “plate-like grains d” were added is referred to as “U (d12)”.

### Comparative Example 3

The liquid drainability of a 0.78% by weight aqueous pectin solution prepared in the same manner as in Example 6, except that pectin was used in place of the thickening stabilizer of Example 6, was evaluated. When the beaker was tilted and then returned to its original position, the 0.78% by weight aqueous pectin solution adhered to the lip of the beaker, and liquid drainability was poor. Further, gel was formed in some places, and the solution did not flow smoothly.

In addition, a 0.35% by weight aqueous solution was prepared in the same manner as in Example 6, except that pectin was used in place of the composition described in Example 6. The grain immobilization index when 20 grains of “plate-like granules a” were added to this dispersion is referred to as “U(a13)”. Similarly, instead of spherical grains a, the grain immobilization index when “spherical grains b” were added is referred to as “U(b13)”. Similarly, instead of spherical grains a, the grain immobilization index when “plate-like grains c” were added is referred to as “U(c13)”. Similarly, instead of spherical grains a, the grain immobilization index when “plate-like grains d” were added is referred to as “U(d13)”.

### Comparative Example 4

A fruit sauce E was prepared by blending 0.82% by weight of guar gum in place of the 0.6% by weight of “composition a” of Example 7. Further, in the same manner as Example 7, strawberry puree was added to the sauce, and the resultant mixture was treated in a similar manner to thereby produce a fruit sauce E′. The fruit sauce E′ was filled into three beakers. When one of the beakers was left to stand under the same conditions as in Example 7, and then tilted and returned to its original position, the fruit sauce E′ adhered to the lip of the beaker forming threads, and liquid drainability was poor. The viscosity (η3β14) at a rotation speed of 3 rpm measured using the fruit sauce E′ filled into the remaining two beakers, which had been left to stand under the same conditions as in Example 7, was 11,800 mPa·s, and the viscosity (η100β14) at a rotation speed of 100 rpm was 1,950 mPa·s. The structural viscosity index (TIβ14) of the fruit sauce E′ at this stage was: TIβ14=(η3β14)/(η100β14)=6, and pH was 3.3. The viscosity (η3β9) at a rotation speed of 3 rpm measured using the fruit sauce A of Example 7, which had been left to stand for 3 hours at 25° C., was 12,700 mPa·s, whereby it was established that η3α9/η3β9 was 1.1. When 1 g of this fruit sauce A′ was respectively given to 20 people, the percentage who felt a sense of pasty feeling was high, at 65%. Further, a fruit sauce E″ was prepared by adding per filled vessel 20 grains of the blueberry granules of Example 7 to this fruit sauce E. 90% of the blueberry granules in the fruit sauce E″ floated on the liquid surface. The grain immobilization index U(e14) was 10% and pH was 3.5.

### Comparative Example 5

Instead of the fruit sauce A of Example 8, the fruit sauce E of Comparative example 4 was used. That is, in place of “composition a”, a soft yoghurt F was prepared using guar gum, and then evaluated. 50% of the blueberry granules in the soft yoghurt F floated on the liquid surface. The grain immobilization index U(e15) was 50% and pH was 4.2.

### Comparative Example 6

A fermented milk drink G was prepared using guar gum in place of the “composition a” of Example 9. The fermented milk drink G was filled into three beakers. When one of the beakers was left to stand under the same conditions as in Example 9, and then tilted and returned to its original position, the fermented milk drink G adhered to the lip of the beaker, and liquid drainability was poor. The viscosity (η3β10) at a rotation speed of 3 rpm measured using the fermented milk drink G filled into the remaining two beakers, which had been left to stand under the same conditions as in Example 9, was 4,020 mPa·s, and the viscosity (η100β10) at a rotation speed of 100 rpm was 353 mPa·s. The structural viscosity index (TIβ10) of the fermented milk drink G at this stage was: TIβ10=(η3β10)/(η100β10)=11, and pH was 3.9. The viscosity (η3α10) at a rotation speed of 3 rpm measured using the fermented milk drink B of Example 9, which had been left to stand for 3 hours at 25° C., was 4,600 mPa·s, whereby it was established that η3α11/η3β10 was 1.1. When 1 g of this fermented milk drink G was respectively given to 20 people, the percentage who felt a sense of pasty feeling was 40%, which was higher than in Example 9.

### Comparative Example 7

A corn syrup H was prepared by using guar gum in place of the “composition a” of Example 10, and then evaluated. All of the corn grains in the corn syrup H sedimented to the bottom, so that the grain immobilization index U(f17) was 0%. pH was 6.8, and dietary salt concentration was 0.73% by weight.

### Example 11

A composition containing the highly dispersible cellulose complex B and guar gum in a weight ratio of 1:9 was selected. A 0.4% by weight aqueous composition dispersion prepared in the same manner as in Example 1 maintained its fluid properties and had not turned into a gel.

Measurement of the theoretical viscosity from the viscosity X7 of this 0.4% by weight aqueous guar gum dispersion (318 mPa·s) and the viscosity Y7 of the 0.4% by weight aqueous highly dispersible cellulose complex B dispersion (2,010 mPa·s) gave a theoretical viscosity α7 of 490 mPa·s. In addition, the relationship between the viscosity Z7 of the 0.4% by weight aqueous composition dispersion (700 mPa·s) and the theoretical viscosity α7 was “viscosity Z7>theoretical viscosity α7”, whereby it was determined that this aqueous composition dispersion had a thickening synergistic effect. Further, the viscosity Z7 (700 mPa·s) of the 0.4% by weight aqueous composition dispersion was at least twice that of the viscosity X7 (318 mPa·s) of the 0.4% by weight aqueous guar gum dispersion. Thus, by simply adding a tiny amount of highly dispersible cellulose, a desired viscosity can be obtained, which holds great promise in terms of cost as a substitute material for food items.

### Comparative Example 8

A composition containing the highly dispersible cellulose complex B and guar gum in a weight ratio of 9:1 was selected. A 0.4% by weight aqueous composition dispersion prepared in the same manner as in Example 1 maintained its fluid properties and had not turned into a gel.

Measurement of the theoretical viscosity from the viscosity X8 of the 0.4% by weight aqueous guar gum dispersion (318 mPa·s) and the viscosity Y8 of the 0.4% by weight aqueous highly dispersible cellulose complex B dispersion (2,010 mPa·s) gave a theoretical viscosity α8 of 1,840 mPa·s. In addition, the relationship between the viscosity Z8 of the 0.4% by weight aqueous composition dispersion (2,350 mPa·s) and the theoretical viscosity a8 was “viscosity Z8>theoretical viscosity α8”, whereby it was determined that this aqueous composition dispersion had a thickening synergistic effect. However, the viscosity Z8 (2,350 mPa·s) of the 0.4% by weight aqueous composition dispersion had only about a 10% thickening synergistic effect compared with the viscosity X8 (2,010 mPa·s) of the 0.4% by weight aqueous highly dispersible cellulose complex B dispersion. Thus, in terms of cost, this does not hold much promise as a substitute material for food items.

### Example 12

A thickening/gelling agent and gelatinous composition were obtained and evaluated in accordance with the following (1) to (8).

(1) Mixed together were the above-described highly dispersible cellulose complex A as first component, glucomannan as a second component, and xanthan gum as a third component in a weight ratio of first component:second component:third component of 5:3.5:1.5, to thereby form a thickening/gelling agent a.

(2) The thickening/gelling agent a was charged into 25° C. water so that its concentration was 1% by weight. The resultant solution was dispersed for 5 minutes using a domestic mixer (manufactured by Sanyo Electric Co., Ltd.) at about 11,000 rpm, to thereby obtain an aqueous gelling agent dispersion. As a result of dispersion, the temperature increased by about 8° C.

(3) This aqueous gelling agent dispersion was then filled to a height of about 45 mm into a heat-resistant cylindrical glass vessel having an inner diameter of about 45 mm.

(4) The dispersion was heat-treated for 1 hour at 90° C. Following the heat treatment, some of the resultant product was stored for 2 hours at 25° C., to thereby obtain a heat-resistant gel A (25° C.), and some of the resultant product was stored for 2 hours at 50° C., to thereby obtain a heat-resistant gel A (50° C.).

(5) The gel rupture strengths of the heat-resistant gel A (25° C.) and heat-resistant gel A (50° C.) were measured under the following conditions. The results are shown in Table 10. High gel rupture strengths were exhibited.

Apparatus: Rheo Meter (NRM-2002J model) (manufactured by Fudou Manufacturing Co., Ltd.)

Pushing jig: 10 mm diameter, spherical jig

Pushing rate: 20 mm/min.

Measuring temperature: 25° C. and 50° C.

(6) Next, the immobilization index was determined. A 1% by weight aqueous gelling agent dispersion was prepared in the same manner as in the above-described (1) and (2). The dispersion was then charged with a plurality of “plate-like grains c” and thoroughly mixed with a spatula.

(7) The “plate-like grains c” was filled into vessels in the same manner as in the above-described (3) so that each vessel contained 20 grains. These vessels were sealed, and then subjected to a heat treatment under the same conditions as the above-described (4).

(8) After the heat treatment was finished, when the solution reached 80° C., the number of “plate-like grains c” which had sedimented or which were floating were counted to determine the immobilization index for evaluating heat resistance. The results are shown in Table 10. The immobilization index exhibits a high value and heat resistance was high.

### Example 13

A first component consisting of highly dispersible cellulose complex A, a second component consisting of the glucomannan of Example 12, and a third component consisting of the xanthan gum of Example 12 were mixed together in a weight ratio of first component:second component:third component of 4:4:2, to thereby form a thickening/gelling agent b.

Next, an aqueous gelling agent dispersion was prepared in the same manner as in Example 12 so that the concentration of the thickening/gelling agent b was 1% by weight. As a result of dispersion the temperature increased by 8° C. This aqueous gelling agent dispersion was then subjected to filling and heat treatment operations in the same manner as in Example 12. The resultant product was stored under the same conditions as in Example 12, to thereby obtain a heat-resistant gel B (25° C.) and a heat-resistant gel B (50° C.). The evaluated results as measured in the same manner as in Example 12 are shown in Table 10. All of the physical properties were good.

### Example 14

A first component consisting of highly dispersible cellulose complex A, a second component consisting of glucomannan, and a third component consisting of the xanthan gum of Example 12 were mixed together in a weight ratio of first component:second component:third component of 3.5:5:1.5, to thereby form a thickening/gelling agent c.

An aqueous gelling agent dispersion was prepared in the same manner as in Example 12 so that the concentration of the thickening/gelling agent c was 1% by weight. As a result of dispersion the temperature increased by 8° C. This aqueous gelling agent dispersion was then subjected to filling and heat treatment operations in the same manner as in Example 12. The resultant product was stored under the same conditions as in Example 12, to thereby obtain a heat-resistant gel C (25° C.) and a heat-resistant gel C (50° C.). The evaluated results as measured in the same manner as in Example 12 are shown in Table 10. Gel rupture strength showed improved results.

### Example 15

A first component consisting of highly dispersible cellulose complex A, a second component consisting of locust bean gum, and a third component consisting of xanthan gum were mixed together in a weight ratio of first component:second component:third component of 5:4:1, to thereby form a thickening/gelling agent d.

An aqueous gelling agent dispersion was prepared in the same manner as in Example 12 so that the concentration of the thickening/gelling agent d was 1% by weight. As a result of dispersion the temperature increased by 7° C. This aqueous gelling agent dispersion was then subjected to filling and heat treatment operations in the same manner as in Example 12. The resultant product was stored under the same conditions as in Example 12, to thereby obtain a heat-resistant gel D (25° C.) and a heat-resistant gel D (50° C.). The evaluated results as measured in the same manner as in Example 12 are shown in Table 11. Heat resistance was excellent.

### Example 16

A first component consisting of highly dispersible cellulose complex A, a second component consisting of locust bean gum, and a third component consisting of xanthan gum were mixed together in a weight ratio of first component:second component:third component of 3.5:5:1.5, to thereby form a thickening/gelling agent e.

An aqueous gelling agent dispersion was prepared in the same manner as in Example 12 so that the concentration of the thickening/gelling agent e was 1% by weight. As a result of dispersion the temperature increased by 7° C. This aqueous gelling agent dispersion was then subjected to filling and heat treatment operations in the same manner as in Example 12. The resultant product was stored under the same conditions as in Example 12, to thereby obtain a heat-resistant gel E (25° C.) and a heat-resistant gel E (50° C.). The evaluated results as measured in the same manner as in Example 12 are shown in Table 11.

### Example 17

A first component consisting of highly dispersible cellulose complex A, a second component consisting of glucomannan, and a third component consisting of xanthan gum were mixed together in a weight ratio of first component:second component:third component of 5:4:1, to thereby form a thickening/gelling agent f. A corn soup gel F serving as an example of a gelatinous composition was prepared and evaluated according to the following procedures by blending this thickening/gelling agent f.

(1) 0.4% by weight of the thickening/gelling agent f was charged into 88.6% by weight of 50° C. water. The resultant solution was dispersed for 3 minutes using the domestic mixer used in Example 12. The solution was then charged with 11% by weight as calculated by solid content of a commercially-available, polysaccharide-free, dry soup (manufactured by Pokka Corporation, from which floating objects had been removed), and the solution was then dispersed for 2 minutes with a propeller stirring blade. The temperature increased by 8° C. The solution was then charged with corn grains (frozen grains which had been thawed, and which had a 10 mm major axis, 8 mm minor axis and 5 mm thickness) and mixed with a spatula. The liquid-state composition had a pH of 6.8 and a dietary salt concentration of 0.73% by weight.

(2) The liquid-state composition was filled into the same vessels and to the same height as in Example 12 so that 10 corn grains per vessel were filled therein. A heat treatment (sterilization treatment) was then conducted for 30 minutes at 121° C. using the same retort sterilizer as in Example 12.

(3) After the sterilization treatment, when the solution reached 80° C., the number of grains which had sedimented or which were floating were counted.

(4) A sample from (3) was subsequently stored for 24 hours at 25° C., to thereby produce a corn soup gel F (25° C.). A separate sample from (3) was stored for 23 hours at 25° C., and then held for 1 hour at a temperature maintained at 50° C., to thereby produce a corn soup gel F (50° C.). Gel rupture strength and stability at the warmed eating temperature were evaluated in the same manner as in Example 12. These results are shown in Table 12. Good heat resistance and gel rupture strength were exhibited. Upon eating the corn soup gel F (50° C.), no sense of pasty feeling was felt, and flavor release was good.

### Example 18

An isotonic jelly G serving as an example of a gelatinous composition was produced according to the following procedures using the thickening/gelling agent a prepared in Example 12, and evaluated.

(1) 1% by weight of the thickening/gelling agent a was charged into 91.6% by weight of 10° C. water. The resultant solution was dispersed for 5 minutes using the domestic mixer used in Example 12. The solution was then charged with 7.4% by weight of a powdered soft drink (manufactured by Otsuka Pharmaceutical Co., Ltd.), and when the solution was dispersed for another 2 minutes with a propeller stirring blade, the temperature increased by 10° C. This liquid-state composition had a pH of 3.5, and contained 520 ppm of sodium, 227 ppm of potassium, 23 ppm of calcium and 6 ppm of magnesium. The composition was further charged with yellow peach (canned peaches which had been cut into “grains” having 5 mm sides), and then mixed with a spatula.

(2) The liquid-state composition was filled into the same vessels and to the same height as in Example 12 so that 10 yellow peach “grains” of per vessel were filled therein. The compositions were then subjected to a heat treatment for 1 hour at 90° C.

(3) After the sterilization treatment, when the solution reached 80° C., the number of grains which had sedimented or which were floating were counted.

(4) A sample from (3) was subsequently stored for 24 hours at 25° C., to thereby produce an isotonic jelly G (25° C.). This was evaluated in the same manner as in Example 12. The results are shown in Table 13. A separate sample from (3) was stored for 23 hours at 25° C., and then held for 1 hour at a temperature maintained at 5° C., to thereby produce a an isotonic jelly G (5° C.). Upon eating the isotonic jelly G (5° C.) at 5° C., no sense of pasty feeling was felt, and flavor release was good.

(5) The liquid-state composition of (1) was filled into a retort pouch and subjected to a heat treatment under the same conditions as in (2) to produce a chew-pack-like drink. This was stored for 23 hours at 25° C., and then held for 1 hour at a temperature maintained at 5° C. Upon drinking it through a straw placed in the pouch, it could be smoothly sucked, no sense of pasty feeling was felt, and flavor release was good.

### Example 19

First, a thickening/gelling agent containing the highly dispersible cellulose complex B, guar gum and xanthan gum in a 3:6.3:0.7 ratio and water were weighed out so that the aqueous solution had a solid content of 1% by weight. This solution was dispersed using the “T.K. AUTO HOMO MIXER” (manufactured by Primix Corporation) at 25° C. and 8,000 rpm for 10 minutes. This 1% by weight aqueous sample dispersion and water were mixed in a ratio of 4:6, and the resultant solution was dispersed for another 5 minutes to prepare a 0.4% by weight aqueous sample dispersion. The thus-prepared dispersion was filled into a beaker.

The 0.4% by weight aqueous sample dispersion filled into the beaker was left to stand for 3 hours in a 25° C. atmosphere. In this standing state, a rotational viscometer (B type viscometer, manufactured by Toki Sangyo Co. Ltd., “TV-10”) was set up, and the viscosity was read out after 60 seconds. The viscosity ηa1 of the three component aqueous thickening/gelling agent dispersion was measured. The rotor rotation speed was set at 3 rpm, and the rotor and adapter were appropriately altered in accordance with the viscosity.

As a comparison, a 0.4% by weight aqueous dispersion was prepared in the same manner by selecting a composition containing the highly dispersible cellulose complex B and guar gum in a 3:6.3 ratio, and the viscosity ηb1 in the case of two components was measured. Further, a 0.4% by weight aqueous dispersion was prepared in the same manner by selecting a composition containing the highly dispersible cellulose complex B and xanthan gum in a 30:7 ratio, and the viscosity ηc1 in the case of two components was measured.

Theoretical viscosity α′1 was determined using the above formula from the viscosity X′1 measured value of the 0.4% by weight aqueous guar gum dispersion (312 mPa·s), the viscosity Y′1 measured value of the 0.4% by weight aqueous highly dispersible cellulose complex dispersion B (2,100 mPa·s), and the viscosity Z′1 measured value of the 0.4% by weight aqueous xanthan gum dispersion (3,500 mPa·s), which were all obtained in the same manner as described above. The theoretical viscosity α′1 was 1,088 mPa·s.

The relationship between the viscosity ηa1 measured value of the 0.4% by weight three component aqueous thickening/gelling agent dispersion (7,800 mPa·s), the viscosity ηb1 measured value (2,710 mPa·s) and the viscosity ηc1 measured value (2,500 mPa·s) of the 0.4% by weight two component thickening/gelling agents, with the theoretical viscosity α′1 (1,088 mPa·s) was that the viscosity ηa1 was greater than all of the theoretical viscosity α′1, viscosity ηb1, and viscosity ηc1). It was thus determined that this three component thickening/gelling agent had a thickening synergistic effect.

In the same manner as in the above-described viscosity measurement, using a 1% by weight aqueous dispersion of the above sample, water was mixed therein so that the viscosity at 60 rpm after the solution had been left to stand for 3 hours at 25° C. was 90 to 100 mPa·s. The obtained aqueous dispersion was filled into a 100 mL sample bottle, and 20 of the above-described “plate-like grains c” were added therein. The resultant mixture was temperature-adjusted for 1 hour at 25° C., after which the mixture was mixed by vigorously shaking the sample bottle up and down. The mixture was left to stand for 3 days at 25° C., and then the number of grains floating on the liquid surface or the number that had sedimented to the bottom was visually counted. The number of grains was plugged into the above-described grain immobilization index (%) formula, whereby the grain immobilization index S was calculated to be 75%.

In the same manner, the grain immobilization index U of an aqueous dispersion which blended guar gum and xanthan gum in a 6.3:0.7 ratio was calculated to be 10%. A comparison of the obtained grain immobilization indices S and U showed that the grain immobilization index S was greater than the grain immobilization index U, whereby it was determined that this thickening/gelling agent had a grain immobilization effect.

### Example 20

As the thickening/gelling agent, a composition containing the highly dispersible cellulose complex B, locust bean gum and xanthan gum in a 5.5:4:0.5 ratio was selected. The viscosity ηa2 as the viscosity of the three component aqueous gelling agent dispersion was measured in the same manner as in Example 19. However, the dispersion temperature of the locust bean gum was set as 85° C.

As a comparison, a 0.4% by weight aqueous dispersion was prepared in the same manner by preparing a composition containing highly dispersible cellulose complex B and locust bean gum in a 5.5:4 ratio, and the viscosity ηb2 as a two component viscosity was measured. Further, a 0.4% by weight aqueous dispersion was prepared in the same manner by selecting a composition containing highly dispersible cellulose complex B and xanthan gum in a 5.5:0.5 ratio, and the viscosity ηc2 as a two component viscosity was measured.

Theoretical viscosity α′2 was determined from the viscosity X′2 measured value of the 0.4% by weight aqueous locust bean gum dispersion (69 mPa·s), the viscosity Y′2 measured value of the 0.4% by weight aqueous highly dispersible cellulose complex dispersion B (2,100 mPa·s), and the viscosity Z′2 measured value of the 0.4% by weight aqueous xanthan gum dispersion (3,500 mPa·s), which were all obtained in the same manner as in Example 19. The theoretical viscosity α′2 was 1,358 mPa·s.

The relationship between the viscosity ηa2 measured value of the 0.4% by weight three component aqueous thickening/gelling agent dispersion (4,470 mPa·s), the viscosity ηb2 measured value (2,410 mPa·s) and the viscosity ηc1 measured value (2,930 mPa·s) of the 0.4% by weight two component thickening/gelling agents, with the theoretical viscosity calculated value α′2 (1,358 mPa·s) was that the viscosity ηa2 was greater than all of the theoretical viscosity α′2, viscosity ηb2, and viscosity ηc2). It was thus determined that this three component thickening/gelling agent had a thickening synergistic effect.

In the same manner as in Example 19, the grain immobilization index S of the thickening/gelling agent was calculated to be 90%. Further, the grain immobilization index U of an aqueous dispersion which blended locust bean gum and xanthan gum in a 4:0.5 ratio was calculated to be 15%. It was determined from these results that this thickening/gelling agent had a grain immobilization effect.

### Example 21

As the thickening/gelling agent, a composition containing the highly dispersible cellulose complex B, glucomannan and xanthan gum in a 6.3:3.0:0.7 ratio was selected. The viscosity ηa3 as the viscosity of the three component aqueous gelling agent dispersion was measured in the same manner as in Example 19.

As a comparison, a 0.4% by weight aqueous dispersion was prepared in the same manner by preparing a composition containing highly dispersible cellulose complex B and glucomannan in a 6.3:3 ratio, and the viscosity ηb3 as a two component viscosity was measured. Further, a 0.4% by weight aqueous dispersion was prepared in the same manner by selecting a composition containing highly dispersible cellulose complex B and glucomannan in a 6.3:0.7 ratio, and the viscosity ηc3 as a two component viscosity was measured.

Theoretical viscosity α′3 was determined from the viscosity X′3 measured value of the 0.4% by weight aqueous glucomannan dispersion (372 mPa·s), the viscosity Y′3 measured value of the 0.4% by weight aqueous highly dispersible cellulose complex dispersion B (2,100 mPa·s), and the viscosity Z′3 measured value of the 0.4% by weight aqueous xanthan gum dispersion (3,500 mPa·s), which were all obtained in the same manner as in Example 19. The theoretical viscosity α′3 was 1,688 mPa·s.

The relationship between the viscosity ηa3 measured value of the 0.4% by weight three component aqueous thickening/gelling agent dispersion (5,670 mPa·s), the viscosity ηb3 measured value (2,750 mPa·s) and the viscosity ηc3 measured value (2,030 mPa·s) of the 0.4% by weight two component thickening/gelling agents, with the theoretical viscosity calculated value α′3 (1,688 mPa·s) was that the viscosity ηa3 was greater than all of the theoretical viscosity α′3, viscosity ηb3, and viscosity ηc3). It was thus determined that this three component thickening/gelling agent had a thickening synergistic effect.

In the same manner as in Example 19, the grain immobilization index S of the thickening/gelling agent was calculated to be 90%. Further, the grain immobilization index U of an aqueous dispersion which blended glucomannan and xanthan gum in a 3:0.7 ratio was calculated to be 20%. It was determined from these results that this thickening/gelling agent had a grain immobilization effect.

### Example 22

As a thickening/gelling agent, a grilled beef sauce was produced according to the following procedures using a composition which blended highly dispersible cellulose complex B, guar gum and xanthan gum in a 4:5.5:0.5 ratio.

44.7% by weight of water was heated to 60° C. and then charged while stirring with a stirrer (“T.K. AUTO HOMO MIXER”, manufactured by Primix Corporation) with a mixed powder consisting of 0.3% by weight of the above-described thickening/gelling agent and 5% by weight of sugar. The resultant mixture was dispersed, and then charged with 10% by weight of syrup (manufactured by Oji Cornstarch Co., Ltd.). This resultant mixed was then dispersed at 8,000 rpm for 10 minutes.

The dispersion apparatus was then replaced with a propeller stirring blade, and the mixture was charged with 25% by weight of soy sauce (manufactured by Kikkoman Co., Ltd; salt concentration of 16%), 5% by weight of dietary salt, 1% by weight of ASAHIAJI (manufactured by Japan Tobacco Inc.), 5% by weight of apple cider vinegar (manufactured by Mizkan Group Co., Ltd.; acidity of 5.0%), 2% by weight of grated onion, 1% by weight of grated garlic, 1% by weight of apple juice (manufactured by Aic Inc.; 100% fruit juice), and the mixture was stirred at 400 rpm.

Further, in a sprinkling manner, 20 grains of coarsely ground pepper (manufactured by S&B Foods Inc.) and 20 grains of Italian parsley (manufactured by S&B Foods Inc were added to the mixture. Stirring was continued for 3 minutes from after the liquid temperature reached 80° C. The thus-sterilized mixture was used as the grilled beef sauce. The thickening/gelling agent content at this point was 0.3% by weight, dietary salt concentration was 9% and pH was 4.2.

The grilled beef sauce was filled into a beaker. The viscosity at 3 rpm after being left to stand for 3 hours in a 25° C. atmosphere was measured to be 2,700 mPa·s, which was higher than the theoretic viscosity as determined for this preparation (998 mPa·s). This grilled beef sauce was filled into a 100 mL sample bottle, and left to stand for 3 days at 25° C. The grain immobilization index was subsequently calculated to be 80%.

### Comparative Example 9

A first component consisting of highly dispersible cellulose complex A and a second component consisting of glucomannan were mixed together in a weight ratio of first component:second component of 7:3, to thereby form a comparison gelling agent g. Comparison gel H (25° C.) and comparison gel H (50° C.) were produced and stored in the same manner as in Example 12, except that this comparison gelling agent g was used instead of the thickening/gelling agent a of Example 12. The evaluated results are shown in Table 10. In addition, the increase in temperature of the aqueous gelling agent dispersion as a result of dispersion was 10° C. Although heat resistance was good, gel rupture strength was too low.

### Comparative Example 10

A second component consisting of glucomannan and a third component consisting of xanthan gum were mixed together in a weight ratio of second component:third component of 5:5, to thereby form a comparison gelling agent h. Comparison gel agent I (25° C.) and comparison gel I (50° C.) were produced and stored in the same manner as in Example 12, except that this comparison gelling agent h was used instead of the thickening/gelling agent a of Example 12. The evaluated results are shown in Table 10. In addition, the increase in temperature of the aqueous gelling agent dispersion as a result of dispersion was 10° C. The results showed that heat resistance was not present.

### Comparative Example 11

A second component consisting of glucomannan and a third component consisting of xanthan gum were mixed together in a weight ratio of second component:third component of 7:3, to thereby form a comparison gelling agent i. Comparison gel J (25° C.) and comparison gel J (50° C.) were produced and stored in the same manner as in Example 12, except that this comparison gelling agent i was used instead of the thickening/gelling agent a of Example 12. The evaluated results are shown in Table 10. In addition, the increase in temperature of the aqueous gelling agent dispersion as a result of dispersion was 10° C.

### Comparative Example 12

A first component consisting of highly dispersible cellulose complex A and a second component consisting of locust bean gum were mixed together in a weight ratio of first component:second component of 5:5, to thereby form a comparison gelling agent j. Comparison gel K (25° C.) and comparison gel K (50° C.) were produced and stored in the same manner as in Example 12, except that this comparison gelling agent j was used instead of the thickening/gelling agent a of Example 12. The evaluated results are shown in Table 11. In addition, the increase in temperature of the aqueous gelling agent dispersion as a result of dispersion was 8° C. While the heat resistance evaluation was barely a “Yes”, gel rupture strength was very low.

### Comparative Example 13

A second component consisting of locust bean gum and a third component consisting of xanthan gum were mixed together in a weight ratio of second component:third component of 5:5, to thereby form a comparison gelling agent k. Comparison gel L (25° C.) and comparison gel L (50° C.) were produced and stored in the same manner as in Example 15, except that this comparison gelling agent k was used instead of the thickening/gelling agent d of Example 15. The evaluated results are shown in Table 11. In addition, the increase in temperature of the aqueous gelling agent dispersion as a result of dispersion was 7° C.

### Comparative Example 14

A second component consisting of locust bean gum and a third component consisting of xanthan gum were mixed together in a weight ratio of second component:third component of 7:3, to thereby form a comparison gelling agent 1. Comparison gelling agent M (25° C.) and comparison gelling agent M (50° C.) were produced and stored in the same manner as in Example 15, except that this comparison gelling agent 1 was used instead of the thickening/gelling agent d of Example 15. The evaluated results are shown in Table 11. In addition, the increase in temperature of the aqueous gelling agent dispersion as a result of dispersion was 7° C.

### Comparative Example 15

A corn soup gel N was prepared in accordance with the same procedures as in Example 17, except that the comparison gelling agent g used in Comparative example 9 was blended in place of the thickening/gelling agent f used in Example 17. The results of an evaluation into gel rupture strength and stability at a warmed eating temperature of the corn soup gel N carried out in the same manner as in Example 12 are shown in Table 12. Gel adhered to the pushing jig, and a precise gel rupture strength could not be obtained. When this gel was eaten, the gel had a rubber-like texture, and was not suitable as a food item.

### Comparative Example 16

A second component consisting of glucomannan and a third component consisting of xanthan gum were mixed together in a weight ratio of second component:third component of 6:4, to thereby form a comparison gelling agent m. A corn soup gel 0 was prepared and evaluated in accordance with the same procedures as in Example 17, except that the comparison gelling agent m was blended in place of the thickening/gelling agent f used in Example 17. The results of an evaluation into gel rupture strength and stability at a warmed eating temperature of the corn soup gel O carried out in the same manner as in Example 17 are shown in Table 12.

### Comparative Example 17

An isotonic jelly P was produced and evaluated in accordance with the same procedures as in Example 18, except that the comparison gelling agent g used in Comparative example 9 was used instead of the thickening/gelling agent a of Example 18. The results of an evaluation into gel rupture strength of the isotonic jelly P carried out in the same manner as in Example 18 are shown in Table 13.

### Comparative Example 18

An isotonic jelly Q was produced and evaluated in accordance with the same procedures as in Example 18, except that blending was carried out with the comparison gelling agent i used in Comparative example 11 instead of the thickening/gelling agent a of Example 18. The results of an evaluation into gel rupture strength of the isotonic jelly Q carried out in the same manner as in Example 18 are shown in Table 13

### Comparative Example 19

A grilled beef sauce was prepared and evaluated in the same manner as in Example 22, except that highly dispersible cellulose complex B and xanthan gum were blended in a 4:0.5 ratio in place of the thickening/gelling agent of Example 22. The viscosity of this grilled beef sauce was 1,170 mPa·s, which was much lower than that for the grilled beef sauce of Example 22.

### Comparative Example 20

A grilled beef sauce was prepared and evaluated in the same manner as in Example 22, except that guar gum and xanthan gum were blended in a 5.5:0.5 ratio in place of the thickening/gelling agent of Example 22. The grain immobilization index of this grilled beef sauce was 10%, which was much lower than that for the grilled beef sauce of Example 22.

[Table 10]

TABLE 10

| | | Heat resistance | | Gel rupture strength | |
|---|---|---|---|---|---|
| | | Immobilization | | | 50° C. |
| | | index | Determination | 25° C. | (reference) |
| Example 12 | Heat | 100% | Yes | 0.85N | 0.25N |
| | resistant | | | | |
| | gel A | | | | |
| Example 13 | Heat | 100% | Yes | 0.80N | 0.20N |
| | resistant | | | | |
| | gel B | | | | |
| Example 14 | Heat | 90% | Yes | 0.95N | 0.15N |
| | resistant | | | | |
| | gel C | | | | |
| Comparative | Comparative | 100% | Yes | 0.15N | 0.13N |
| example 9 | gel H | | | | |
| Comparative | Comparative | 0% | No | 1.3N | Unmeasurable |
| example 10 | gel I | | | | (turned into |
| | | | | | a fluid) |
| Comparative | Comparative | 0% | No | 2.1N | Unmeasurable |
| example 11 | gel J | | | | (turned into |
| | | | | | a fluid) |

<Heat resistance determination criteria>
Yes: Heat resistance present (immobilization index of 70% or greater)
No: Heat resistance not present (immobilization index of less than 70%)

[Table 11]

TABLE 11

| | | Heat resistance | | Gel rupture strength | |
|---|---|---|---|---|---|
| | | Immobilization | | | 50° C. |
| | | index | Determination | 25° C. | (reference) |
| Example 15 | Heat | 100% | Yes | 0.18N | 0.10N |
| | resistant | | | | |
| | gel D | | | | |
| Example 16 | Heat | 90% | Yes | 0.39N | 0.11N |
| | resistant | | | | |
| | gel E | | | | |
| Comparative | Comparative | 80% | Yes | 0.08N | 0.05N |
| example 12 | gel K | | | | |
| Comparative | Comparative | 0% | No | 0.47N | Unmeasurable |
| example 13 | gel L | | | | (turned into |
| | | | | | a fluid) |
| Comparative | Comparative | 0% | No | 0.95N | Unmeasurable |
| example 14 | gel M | | | | (turned into |
| | | | | | a fluid) |

<Heat resistance determination criteria>
Yes: Heat resistance present (immobilization index of 70% or greater)
No: Heat resistance not present (immobilization index of less than 70%)

[Table 12]

TABLE 12

| | | Heat resistance | | Gel rupture strength | |
|---|---|---|---|---|---|
| | | Immobilization | | | 50° C. |
| | | index | Determination | 25° C. | (reference) |
| Example 17 | Corn soup | 100% | Yes | 0.35N | 0.22N |
| | gel F | | | | |
| Comparative | Corn soup | 100% | Yes | Unmeasurable | Unmeasurable |
| example 15 | gel N | | | | |
| Comparative | Corn soup | 60% | No | 0.20N | 0.07N |
| example 16 | gel O | | | | |

<Heat resistance determination criteria>
Yes: Heat resistance present (immobilization index of 70% or greater)
No: Heat resistance not present (immobilization index of less than 70%)

[Table 13]

TABLE 13

| | | Heat resistance | | Gel rupture |
|---|---|---|---|---|
| | | Immobilization | | strength |
| | | index | Determination | 25° C. |
| Example 18 | Isotonic | 100% | Yes | 0.17 N |
| | jelly G | | | |
| Comparative | Isotonic | 100% | Yes | 0.04 N |
| example 17 | jelly P | | | |
| Comparative | Isotonic | 0% | No | 0.72 N |
| example 18 | jelly Q | | | |

<Heat resistance determination criteria>
Yes: Heat resistance present (immobilization index of 70% or greater)
No: Heat resistance not present (immobilization index of less than 70%)

### Example 23

A gelling agent was prepared and a standard gel obtained and evaluated in accordance with the following items (1) to (16).

(1) Mixed together were the above-described highly dispersible cellulose complex B as a first component, glucomannan as a second component, and xanthan gum as a third component in a weight ratio of first component:second component:third component of 5:4:1, to thereby form a gelling agent n.

(2) The gelling agent n was charged into 25° C. ion exchange water so that its concentration was 0.92% by weight. The resultant solution was dispersed for 5 minutes using a domestic mixer (manufactured by Sanyo Electric Co., Ltd.) at about 11,000 rpm, to thereby obtain an aqueous gelling agent dispersion. As a result of dispersion, the temperature increased by about 8° C.

(3) To confirm heat resistance, the aqueous gelling agent dispersion was used as a test sample. The sample was charged with a plurality of “plate-like grains c”, and the resultant solution was mixed with a spatula.

(4) This solution was then filled to a height of about 45 mm into cylindrical glass vessels having an inner diameter of about 45 mm so that 20“plate-like grains c” per vessel were contained therein. The vessels were then sealed.

(5) The resultant solution was heat-treated for 30 minutes at 120° C.

(6) After the heat treatment had finished, the solution was cooled for 3 hours at 25° C. while maintaining in a standing state. The number of grains floating on the liquid surface and the number that had sedimented to the bottom were counted.

(7) Determination of heat resistance: Based on the respective number of grains counted in item (6), the immobilization index was calculated.

(8) To determine the rupture strength, rupture strain factor and brittleness strain factor of a standard gel, heat resistant wrap was stuck onto one side of the lip portion of cylindrical vessels made from stainless steel having an inner diameter of about 45 mm and a height of 5 cm. The wrap was held with a rubber band to prepare the vessels to be used for filling the gel.

(9) An aqueous gelling agent dispersion was prepared (but no grains were added therein) in the same manner as items (1) to (2). The prepared dispersion was then used as a test sample and filled into the vessels to a height of about 40 mm.

(10) Heat resistant wrap was wrapped around the vessels and held with a rubber band to seal the vessels.

(11) The vessels containing the gel were heated in an 80° C. water bath for 1 hour, and then cooled at 5° C. for 24 hours.

(12) The wrap at the upper portion and lower portion of the vessels was removed, and each vessel was placed upside down on the test stand of a rheometer so that the bottom of the gel faced upwards.

(13) The vessels were carefully removed, and in a state such that only the gel was mounted on the test stand, the sample thickness (mm) was measured under the following conditions.

Apparatus: Rheometer (RE-33005-1; manufactured by Yamaden Co., Ltd.)

Mode: Rupture strength analysis

Load cell: 2 kg

Pushing rate: 1 mm/sec.

Pushing jig: 12 mm diameter×25 mm cylinder

Measuring temperature: 5° C.

(14) From the obtained rupture pattern, the “rupture strength (N)” was read out as 1.40 N. Subsequently, the “rupture deformation (mm)” and “brittleness deformation (mm)” were also read out.

(15) The rupture strain factor for the standard gel was calculated from the sample thickness measured in item (13) and the rupture deformation (mm) obtained in item (14). The results are shown in Table 14.

(16) The brittleness strain factor is the ratio of the brittleness deformation to the thickness of the original sample, and was calculated from the sample thickness measured in item (13) and the brittleness deformation (mm) obtained in item (14). The results are shown in Table 14.

From the above, it was learned that a gel having high heat resistance could be obtained which exhibited excellent grain immobilization even at high temperatures comparable to those of retort sterilization despite gelatin-like physical properties being exhibited.

### Example 24

Highly dispersible cellulose complex B as the first component, locust bean gum as the second component polysaccharide, and xanthan gum as the third component were mixed together in a weight (ratio of first component:second component:third component of 35:50:15, to thereby form a gelling agent o. A standard gel was produced and evaluated in the same manner as in Example 23, so that the gelling agent o concentration was 1% by weight.

The rupture strength was 1.42 N. The measured results of the immobilization index, rupture strain factor and brittleness strain factor used for heat resistance evaluation are shown in Table 14. A gelatin-like gel having heat resistance was obtained.

### Example 25

Highly dispersible cellulose complex B as the first component, locust bean gum and gellan gum as the second component polysaccharide, and xanthan gum as the third component were mixed together in a weight ratio of first component:second component:third component of 4:5:1, to thereby form a gelling agent p (here, the ratio between locust bean gum and gellan gum in the polysaccharide serving as the second component was a weight ratio of 3.5:1.5).

The gelling agent p was charged into 25° C. ion exchange water so that its concentration was 0.96% by weight. The resultant solution was dispersed for 5 minutes using the domestic mixer used in Example 23, and was then heated to 95° C. while stirring with a propeller stirring blade. The resultant solution was sprinkled with 0.25% of calcium lactate and then stirred. This solution was used as an aqueous gelling agent dispersion to prepare for evaluation a standard gel in the same manner as in Example 23.

The rupture strength was 1.37 N. The obtained immobilization index, rupture strain factor and brittleness strain factor used for heat resistance evaluation are shown in Table 14. A heat resistant gel was obtained despite having agar-like characteristics.

### Example 26

Highly dispersible cellulose complex B as the first component, glucomannan as the second component polysaccharide, and xanthan gum as the third component were mixed together in a weight ratio of first component:second component:third component of 5:3.5:1.5, to thereby form a gelling agent q. Using this gelling agent q, a peach jelly was produced and evaluated. The pH of the prepared blank solution without adding a gelling agent was 6.3.

An aqueous gelling agent dispersion was prepared in the same manner as in Example 23 so that the gelling agent q concentration was 1% by weight. The resultant solution was charged with 5% by weight of granulated sugar (manufactured by Daiichi-Togyo Co., Ltd.), and mixed to thereby obtain a peach jelly.

Using this peach jelly as a test sample, peach “grains” cut into cubes having 7 mm sides were charged into the jelly, and the resultant solution was then uniformly mixed with a spatula. This solution was then filled to a height of about 45 mm into cylindrical glass vessels having an inner diameter of about 45 mm so that 10 “grains” per vessel were contained therein. The vessels were then sealed. The resultant solution was heated for 30 minutes at 105° C. After heating, the solution was cooled for 3 hours at 25° C. while maintaining in a standing state. The number of grains floating on the liquid surface of the peach jelly and the number that had sedimented to the bottom were counted. The immobilization index was calculated in the same manner as in Example 23.

Next, the rupture strength, rupture strain factor and brittleness strain factor of the peach jelly were measured. This peach jelly solution was used as a test sample for evaluation in the same manner as in Example 23. The rupture strength was 1.38 N. The immobilization index was 90%, and it was determined that heat resistance was present. The rupture strain factor was 43% and the brittleness strain factor was 2%. A gelatin-like gelatinous composition was obtained having heat resistance.

### Example 27

Using the gelling agent p used in Example 25, a fruit juice jelly was produced and evaluated. The pH of the prepared blank solution without adding a gelling agent and calcium lactate was 4.2.

An aqueous gelling agent dispersion was prepared in the same manner as in Example 25 so that the gelling agent p concentration was 0.93% by weight. The resultant solution was heated to 95° C. while stirring with a propeller stirring blade, and then charged with 5% by weight of granulated sugar (manufactured by Daiichi-Togyo Co., Ltd.) and 10% by weight of raspberry puree. The resultant solution was mixed to thereby obtain a fruit juice jelly.

Using this fruit juice jelly as a test sample, blueberry “grains” (diameter of 10 mm) were charged into the jelly, and the resultant solution was then uniformly mixed with a spatula. This solution was then filled to a height of about 45 mm into cylindrical glass vessels having an inner diameter of about 45 mm so that 5 “grains” per vessel were contained therein. The vessels were then sealed. The resultant solution was heated for 10 minutes at 95° C. After heating, the solution was cooled for 3 hours at 25° C. while maintaining in a standing state. The number of grains floating on the liquid surface of the fruit juice jelly and the number that had sedimented to the bottom were counted. The immobilization index was calculated in the same manner as in Example 23.

Next, the rupture strength, rupture strain factor and brittleness strain factor of the fruit juice jelly were measured. This fruit juice jelly solution was used as a test sample for evaluation in the same manner as in Example 23. The rupture strength was 1.46 N.

The immobilization index was 80%, and it was determined that heat resistance was present. The rupture strain factor was 13% and the brittleness strain factor was 12%. A gelatinous composition having agar-like characteristics was obtained.

### Comparative Example 21

A first component consisting of highly dispersible cellulose complex B and a second component polysaccharide consisting of glucomannan were mixed together in a weight ratio of first component:second component of 7:3, to thereby form a comparison gelling agent r. A standard gel was produced and evaluated in the same manner as in Example 23 so that the comparison gelling agent r concentration was 1.2% by weight. At this point, the viscosity from the comparison gelling agent was severe, so that a standard gel having a concentration higher than 1.2% could not be prepared. Rupture strength was 0.51 N, so that with just the two constituent components a standard gel having a rupture strength of 1.4 to 1.5, which is a prerequisite when measuring rupture strain factor and brittleness strain factor, could not be prepared.

### Comparative Example 22

A first component consisting of highly dispersible cellulose complex B and a second component polysaccharide consisting of locust bean gum were mixed together in a weight ratio of first component:second component of 5:5, to thereby form a comparison gelling agent s. A standard gel was produced and evaluated in the same manner as in Example 23 so that the comparison gelling agent s concentration was 1.2% by weight. At this point, the viscosity from the comparison gelling agent was severe, so that a standard gel having a concentration higher than 1.2% could not be prepared. Rupture strength was 0.37 N, so that with just the two constituent components a standard gel having a rupture strength of 1.4 to 1.5, which is a prerequisite when measuring rupture strain factor and brittleness strain factor, could not be prepared.

### Comparative Example 23

Instead of the gelling agent of Example 23, 2.5% by weight of gelatin was charged into 95° C. ion exchange water, and dissolved by stirring with a propeller stirring blade for 10 minutes. Using this gelatin solution, a standard gel was prepared and evaluated in the same manner as in Example 23. The rupture strength was 1.4 N. The immobilization index was 0%, and heat resistance was not present. The rupture strain factor was 39% and the brittleness strain factor was 2%.

### Comparative Example 24

Instead of the gelling agent of Example 23, 0.63% by weight of agar was charged into 95° C. ion exchange water, and dissolved by stirring with a propeller stirring blade for 10 minutes. Using this agar solution, a standard gel was prepared and evaluated in the same manner as in Example 23. The rupture strength was 1.45 N. The immobilization index was 0%, and heat resistance was not present. The rupture strain factor was 16% and the brittleness strain factor was 7%.

### Comparative Example 25

Instead of the gelling agent of Example 23, 0.11% by weight of gellan gum was charged into 95° C. ion exchange water, and dissolved by stirring with a propeller stirring blade for 10 minutes. 0.1% by weight of calcium lactate was further sprinkled thereon. Using this gellan gum solution, a standard gel was prepared and evaluated in the same manner as in Example 23. The rupture strength was 1.41 N. The immobilization index was 20%, and heat resistance was not present. The rupture strain factor was 13% and the brittleness strain factor was 1%, thus showing that a very brittle gel was formed.

### Comparative Example 26

A second component polysaccharide consisting of locust bean gum and a third component consisting of xanthan gum were mixed together in a weight ratio of second component:third component of 5:3, to thereby form a comparison gelling agent t. A standard gel was produced and evaluated in the same manner as in Example 23 so that the comparison gelling agent t concentration was 0.55% by weight. The rupture strength was 1.44 N. The immobilization index was 10%, and heat resistance was not present. The rupture strain factor was 57% and the brittleness strain factor was 2%, thus showing rice-cake physical properties wherein stretching was excessively large.

### Comparative Example 27

A peach jelly was produced in the same manner as in Example 26, except that 2.6% by weight of gelatin was used instead of the gelling agent q of Example 26. This gelatin, however, had been charged into 95° C. ion exchange water and dissolved by stirring with a propeller stirring blade for 10 minutes. The rupture strength was 1.47 N. The immobilization index was 0%, and heat resistance was not present. The rupture strain factor was 40% and the brittleness strain factor was 2%.

### Comparative Example 28

A fruit juice jelly was produced in the same manner as in Example 27, except that 0.15% by weight of gellan gum was used instead of the gelling agent p of Example 27. 0.15% by weight of calcium lactate was further sprinkled thereon. The immobilization index was 10%, and heat resistance was not present. While the rupture strength was 1.46 N (reference value), the raspberry puree fibers did not uniformly form in the gel, thus making it impossible to accurately measure the rupture strength, rupture strain factor and brittleness strain factor.

### Comparative Example 29

A first component consisting of the above-described highly dispersible cellulose complex B, a second component polysaccharide consisting of locust bean gum and a third component consisting of xanthan gum were mixed together in a weight ratio of first: component:second component:third component of 2:4:4, to thereby form a comparison gelling agent u. A standard gel was produced and evaluated in the same manner as in Example 23 so that the comparison gelling agent u concentration was 0.6% by weight. The rupture strength was 1.40 N. The immobilization index was 30%, and heat resistance was not present. The rupture strain factor was 50% and the brittleness strain factor was 2%.

[Table 14]

TABLE 14

| | Gel physical properties | | | |
|---|---|---|---|---|
| | Rupture | Brittleness | Heat resistance | |
| | strain | strain factor | Immobilization | |
| | factor (%) | (%) | index | Determination |
| Example 23 | 40 | 5 | 100% | Yes |
| Example 24 | 35 | 6 | 70% | Yes |
| Example 25 | 12 | 12 | 90% | Yes |

<Heat resistance determination criteria>
Yes: Heat resistance present (immobilization index of 60% or greater)
No: Heat resistance not present (immobilization index of less than 60%)

### INDUSTRIAL APPLICABILITY

The composition according to the present invention comprises a water-dispersible cellulose which is a fine-fibrous cellulose, and at least one kind of polysaccharide, has high grain immobilizing and thickening synergistic effects, can suppress sedimentation and floating of grains in the flesh of a fruit or the like without adversely effecting feeling such as a sense of pasty feeling, and can attain a desired thickening effect using a small amount. In other words, the added amount of thickening agent can be reduced. Further, the composition according to the present invention which comprises a water-dispersible cellulose which is a fine-fibrous cellulose, at least one kind of polysaccharide, and xanthan gum, is not derived from animals, and can provide a gelatinous substance having physical properties which are normally preferred when used in a food item or the like, and can form a heat resistant gel which can stably maintain grains contained in a gel even when subjected to conditions such as those found in retort sterilization. This quality can be used not only in food-related fields, but also in applications such as pharmaceuticals, cosmetics and the like.

1. A composition comprising a highly dispersible cellulose complex and a polysaccharide in a weight ratio of 1:9 to 8:2, wherein the highly dispersible cellulose complex is a dry composition consisting of:
i) 50 to 95% by weight of a water-dispersible cellulose;
ii) 1 to 49% by weight of a water-soluble polymer; and
iii) 1 to 49% by weight of a hydrophilic substance,
the water-dispersible cellulose originating from plant cell walls as a raw material and being a fine-fibrous cellulose having a major axis of 0.5 to 30 μm, a minor axis of 2 to 600 nm, and a major axis/minor axis ratio of 20 to 400, the water-dispersible cellulose component comprising 10% by weight or more of a component stably suspensible in water, and having a loss tangent of less than 1 when formed as a 0.5% by weight aqueous dispersion.

2. The composition according to claim 1, wherein the highly dispersible cellulose complex is a dry composition consisting of:
i) 55 to 85% by weight of a water-dispersible cellulose;
ii) 1 to 30% by weight of a water-soluble polymer; and
iii) 5 to 40% by weight of a hydrophilic substance.

3. The composition according to claim 1 having a weight ratio of the water-dispersible cellulose: the total of the water-soluble polymer and the hydrophilic substance: the polysaccharide of 0.5:0.5:9 to 7.6:0.4:2.

4. The composition according to claim 1 having a weight ratio of the water-dispersible cellulose: the total of the water-soluble polymer and the hydrophilic substance: the polysaccharide of 0.55:0.45:9 to 6.8:1.2:2.

5. A stabilizer for grain immobilizing which comprises the composition according to claim 1, wherein the polysaccharide contains at least one selected from the group consisting of galactomannan, glucomannan, sodium alginate, tamarind seed gum, pectin, carrageenan, gellan gum, agar, sodium carboxymethyl cellulose, soybean water-soluble polysaccharide, karaya gum, psyllium seed gum, pullulan, gum arabic, tragacanth gum, gum ghatti, arabinogalactan and curdlan.

6. A stabilizer for grain immobilizing which comprises the composition according to claim 1, wherein the polysaccharide contains at least one selected from the group consisting of galactomannan, glucomannan, sodium alginate, tamarind seed gum, gellan gum, sodium carboxymethyl cellulose, soybean water-soluble polysaccharide, karaya gum and gum arabic.

7. A thickening agent which comprises the composition according to claim 1, wherein the polysaccharide contains at least one selected from the group consisting of galactomannan, glucomannan, sodium alginate, tamarind seed gum, pectin, carrageenan, gellan gum, agar, sodium carboxymethyl cellulose, soybean water-soluble polysaccharide, karaya gum, psyllium seed gum, pullulan, gum arabic, tragacanth gum, gum ghatti, arabinogalactan and curdlan.

8. A thickening agent which comprises the composition according to claim 1, wherein the polysaccharide contains at least one selected from the group consisting of galactomannan, glucomannan, sodium alginate, tamarind seed gum, gellan gum, sodium carboxymethyl cellulose, soybean water-soluble polysaccharide, karaya gum and gum arabic.

9. The composition according to claim 1, wherein the water-dispersible cellulose comprises 30% by weight or more of a component stably suspensible in water.

10. The composition according to claim 1, wherein the composition can easily disperse in an aqueous 0.01% calcium chloride solution.

11. The composition according to claim 1, wherein the water-dispersible cellulose has a crystallinity exceeding 50%.

12. The composition according to claim 1, wherein the water-soluble polymer is at least one selected from the group consisting of gum arabic, xanthan gum, sodium carboxymethyl cellulose, gellan gum, and indigestible dextrin.

13. The composition according to claim 1, wherein the hydrophilic substance is at least one selected from dextrins and trehalose.

14. A food item comprising the composition according to claim 1.

15. A thickening/gelling agent comprising the composition according to claim 1, which comprises the highly dispersible cellulose complex, polysaccharide and xanthan gum, wherein the polysaccharide is at least one selected from the group consisting of galactomannan, glucomannan, sodium alginate and deacetylated gellan gum.

16. The thickening/gelling agent according to claim 15, wherein the polysaccharide is galactomannan or glucomannan.

17. The thickening/gelling agent according to claim 15, having a weight ratio of the total of the highly dispersible cellulose complex and polysaccharide: xanthan gum of 7:3 to 9.9:0.1.

18. The thickening/gelling agent according to claim 15, wherein the water-dispersible cellulose comprises 30% by weight or more of a component stably suspensible in water.

19. The thickening/gelling agent according to claim 15, wherein the composition can easily disperse in an aqueous 0.01% calcium chloride solution.

20. The thickening/gelling agent according to claim 15, wherein the water-dispersible cellulose has a crystallinity exceeding 50%.

21. The gelling agent according claim 15, wherein when formed as a standard gel having a rupture strength of 1.4 N to 1.5 N, rupture strain factor is 33 to 45%, and brittleness strain factor is 1 to 10%.

22. The gelling agent according to claim 15, wherein when formed as a standard gel having a rupture strength of 1.4 N to 1.5 N, rupture strain factor is 7 to 20%, and brittleness strain factor is 2 to 15%.

23. A food item comprising the thickening/gelling agent or gelling agent according to claim 15.

24. A liquid-state composition comprising the composition according to claim 1.

25. A gelatinous composition comprising the thickening/gelling agent or gelling agent according to claim 15.
